(19) United States
(12) Patent Application Publication
(10) Pub. No.: US 2025/0350689 A1
(43) Pub. Date: Nov. 13, 2025

(54) INTRAVENOUS DOFETILIDE AND USES THEREOF

(71) Applicant: Hyloris Developments SA, Liège (BE)

(72) Inventor: John Somberg, Lake Forest, IL (US)

(21) Appl. No.: 19/278,179

(22) Filed: Jul. 23, 2025

Related U.S. Application Data
(63) Continuation of application No. PCT/EP2024/052388, filed on Jan. 31, 2024.
Application No. PCT/EP2024/052388 is a continuation of application No. 18/162,082, filed on Jan. 31, 2023, now Pat. No. 12,267,465.
Application No. 18/162,082 is a continuation of application No. 18/175,971, filed on Feb. 28, 2023.
Application No. 18/175,971 is a continuation of application No. 18/176,017, filed on Feb. 28, 2023.

(51) Int. Cl. H04N 1/00

(52) U.S. Cl. CPC H04N 1/00039; H04N 1/00005; H04N 1/00079; H04N 1/00087; H04N 1/00334; H04N 1/0044; H04N 1/00482

(57) ABSTRACT

The present invention involves novel safe dosage regimens comprising the administration of a loading and maintenance dose of dofetilide iv, followed by oral dosing of dofetilide. Methods include (a) reducing the risk of developing atrial fibrillation (AF) and/or atrial flutter (AFL) post coronary bypass surgery (CABS); (b) terminating arrhythmic storm in patients following implementation of an implantable defibrillator by administrating loading and maintenance infusions of dofetilide intravenously followed by oral dosing; and, (c) converting atrial fibrillation (AF) or atrial flutter (AFL) in a patient presenting with highly symptomatic AF or AFL.

### FIELD OF THE INVENTION

The present invention involves a novel method of reducing the risk of developing atrial fibrillation (AF) and/or atrial flutter (AFL) post coronary bypass surgery (CABS) by administering dofetilide intravenously to patients who have undergone CABS.

The invention further involves a novel method of administering dofetilide intravenously to terminate arrhythmic storm in patients following implantation of a cardiac defibrillator.

The invention further involves a novel method of administering dofetilide intravenously to convert atrial fibrillation (AF) or atrial flutter (AFL) in patients presenting with highly symptomatic AF or AFL.

### BACKGROUND OF THE INVENTION

Dofetilide is an anti-arrhythmic of the Vaughn Williams Class III. Its action is to prolong the action potential duration, specifically by prolonging repolarization time. Dofetilide does this by blocking the outward potassium channel IKr (rapid potassium rectifier current). This action is both anti-arrhythmic and pro-arrhythmic. Excessive prolongation of the repolarization time may give rise to life threatening arrhythmias, especially those called Torsade de Pointe ventricular tachycardia (Tpd). The repolarization time of cardiac cells may be manifest on the body surface ECG (electrocardiogram) by an increase in the QT interval. Since the QT interval varies with heart rate, often the QT interval is measured as the heart rate corrected QT, called the QT_{c}. Prolongation of the QT_{c} interval by pharmaceutical agents may give rise to arrhythmias. Thus, in the initial loading phase, or in a dose escalation procedure, it is critical to monitor the QT_{c} interval to avoid excessive QT_{c} prolongation and thus the possible development of life-threatening ventricular tachycardia's, especially those of the Tdp variety. For these reasons the FDA has mandated in-hospital QT_{c} monitoring in initial dofetilide loading or for dose escalation. But, for a patient in need of chronic dofetilide therapy (e.g., a patient who presents with intermittent AF but who is in current sinus rhythm), it takes at least 3 days for oral dofetilide to reach a steady state concentration and thus for the concentration to be reflected in full expression in QT_{c} prolongation. Patients, therefore, typically require a 3 day hospital stay to prevent endangering themselves to possible arrhythmias occurring outside the hospital where help is often not available.

The relationship between blood concentration of dofetilide and QT_{c} can be expressed as: QT_{c}=baseline QT_{c}+(slope relationship×blood dofetilide concentration). The relationship between dofetilide plasma concentration and QT_{c} has been previously established. The QT_{c} changes between 15-25 msec/ng/mL (average=20 msec) as reported by Sedgwick et al, Br J. Clin Pharmacol 1991:31:515-519. Thus, for a patient with an initial QT_{c} of 405 msec QT who received an IV dose of 2.4 μg/kg, which would be analogous to a chronic dose of 500 μg bid, it would be expected to show a QT_{c} of 459 msec on average, a 13% increase over baseline, within acceptable limits.

$${QT}_{c} = 405 msec + ( 20 msec / ng / mL \times 2.7 ng / mL ) = 459 msec$$

When administering dofetilide, a physician first assesses the QT_{c} interval. If the QT_{c} is greater than 440 msec (500 msec in patients with ventricular conduction abnormalities), dofetilide is not indicated. The physician then calculates the patient's creatinine clearance (CrCl, which is a useful approximation of the glomerular filtration rate (GFR)) employing the following formulas:

$$Creatinine clearance ( male ) = ( ( 140 - Age ) \times Body Wt ( kg ) ) / ( 72 \times serum creatinine ( mg / dL ) )$$

$$Creatinine clearance ( female ) = Creatine clearance ( male ) \times 0.85$$

Following calculation of CrCl, the starting dose of dofetilide is determined as shown below.

| Creatinine Clearance (CrCl) | | Starting Dose of Dofetilide |
|---|---|---|
| 60 | mL/min or more | 500 μg bid |
| 40-<60 | mL/min | 250 μg bid |
| 20-<40 | mL/min | 125 μg bid |
| <20 | mL/min | Dofetilide not indicated |

The physician then must monitor the QT_{c} till steady state is achieved, in this case 5-6 doses, or 3 days in hospital with ECG monitoring. This is a costly, time intensive procedure and impractical when the goal is to rapidly load dofetilide to prevent AF/AFL in the immediate post-operative period.

U.S. Pat. No. 11,364,213 (US '213) involves a method of reducing the 3-day loading period for patients in need of chronic, oral dofetilide. Generally, these patients, who typically present with intermittent AF but are in current sinus rhythm, are given a first intravenous dofetilide dose followed by twice daily (BID) oral dofetilide. US '213 describes how the claimed method can assess the risk of dofetilide in the patient in one day or less, thereby reducing costs, e.g., hospital costs, for initiating chronic oral dofetilide therapy.

In the United States there are approximately four hundred thousand open heart coronary bypass operations a year and an additional 100,000 cardiac valve surgeries. Due to opening the pericardial cavity, the manipulation of the heart and the placing of temporary atrial pacing leads there is between a 30-50% incidence of post-operative AF/AFL 3 to 5 days post-operative. AF/AFL can be very rapid causing symptoms and hemodynamic patient compromise. AF/AFL post-operatively can cause serious complications and significantly prolong the patient's hospitalization.

Dofetilide is an effective agent that can prevent AF/AFL. However, the time necessary to load dofetilide orally, the only currently approved method of administration, makes its use less effective in preventing early onset AF/AFL. An IV loading dose could quickly obtain an effective concentration. However, dofetilide can cause QT prolongation that can, when excessive, lead to the development of life-threatening ventricular arrhythmias.

Therefore, it would be beneficial to develop a method of using dofetilide to prevent AF and/or AFL in patients undergoing open heart coronary bypass.

The situation above applies to a patient in need of chronic dofetilide therapy, particularly a patient who is in arrhythmic storm. Currently, it takes at least 3 days for oral dofetilide to reach a steady state concentration. This is unsatisfactory.

The physician then must monitor the QTc till steady state is achieved, in this case 5-6 doses, or 3 days in hospital with ECG monitoring. This is impractical when the goal is to rapidly terminate arrhythmic storm and prevent its recurrence.

The availability of the implantable defibrillators for patients who have had a “sudden death” arrest or for patients at high risk for a life-threatening ventricular arrhythmia has greatly benefited patients. The implantable defibrillator (ID) has significantly reduced the incidence of arrhythmic death in patients at high risk for a cardia arrest. Patients with severe heart failure, patients who survived a cardiac arrest, and patients with recent ventricular tachycardia have all benefited from the availability of the ID.

However, the procedure of implementation and the testing of the ID can cause recurrent, incessant ventricular tachycardia (VT) and ventricular fibrillation (VF). At times terminating these incessant arrhythmias can be very difficult to treat, with many currently available drugs ineffective. The incessant, recurrent aspect of the arrhythmic storm is especially prevalent in patients with poor left ventricular function. Patients with poor heart function are also patients in which many anti-arrhythmic drugs facilitate arrhythmias (pro-arrhythmia). Dofetilide, a Vaughan Williams type 111 anti-arrhythmic that prolongs cardiac repolarization has been shown to be safe in patients with poor heart function (Diamond Study (Torp-Pedersen et al NEJM 1999; 341:857-65)). However, it has been impractical to use oral dofetilide for the treatment of arrhythmic storm since oral dofetilide has required a 3-day in hospital loading regimen whereas arrhythmic storm is a condition needing immediate treatment.

Thus, it would be beneficial to develop a method for intravenously administering dofetilide for the treatment of arrhythmic storm with a rapid loading paradigm. An important aspect is patient safety.

Atrial Fibrillation (AF) or Atrial Flutter (AFL) can be highly symptomatic and in patients with compromised myocardial function can lead to cardiac decompensation and possible death. Symptomatic AF/AFL can be terminated with the patient returning to normal sinus rhythm with pharmacologic therapy or electrical cardioversion. Dofetilide is known to be effective in converting AF/AFL and preventing recurrence of the arrhythmia. Dofetilide is approved by the U.S. Food and Drug Administration for conversion of symptomatic AF/AFL. However, administering the drug orally over several days, the currently approved methodology, is a substantial impediment to conversion, especially in situations where conversion is urgent given the patient's condition. A rapid infusion of an IV formulation of dofetilide would be effective in conversion, but dofetilide can cause excessive QT prolongation that can lead to the development of serious, life-threatening ventricular arrhythmia of the Torsade de Pointe kind.

Thus, it would be beneficial to develop a method for the effective administration of an IV formulation of dofetilide that can be administered in a controlled way with careful patient assessment to avoid the precipitation of life-threatening drug induced arrhythmias (pro-arrhythmia). This is especially needed in patients with reduced heart function since many drugs in patients with heart failure are more prone to precipitate life threatening arrhythmias. AF/AFL is frequent in patients with a reduced heart function and dofetilide in clinical studies was found not to increase life threatening arrhythmias in this heart failure population.

### SUMMARY OF THE INVENTION

Accordingly, the present invention involves a novel and safe method of intravenously loading and maintaining dofetilide in a patient and safely switching over to oral dofetilide intake. Particularly, the present invention provides a pharmaceutical dofetilide iv composition for use in the treatment of a patient in need thereof, comprising the step of
I. intravenously administering a loading dose of dofetilide to the patient, wherein the loading dose is administered over 30-60 minutes,
II. 0-4 hours after completion of the IV loading dose, intravenously administering a maintenance infusion of dofetilide over 12 hours,
III. when the patient is capable of taking dofetilide orally, stopping the IV maintenance infusion; and,
IV. 2-6 hours after stopping the IV maintenance infusion, orally administering dofetilide every 12 hours;
V. wherein the maintenance infusion given is based on the creatinine clearance (CrCl) of the patient as given in the following table

| | | IV Maintenance Infusion | Oral Dose |
|---|---|---|---|
| CrCl | | (over 12 hrs) | (every 12 hrs) |
| ≥60 | mL/min | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

VI. and wherein a QT_{c} of the patient is measured prior to the IV loading dose of dofetilide to establish a baseline QT_{c} and then measuring the QT_{c} every 15-30 minutes thereafter for 60 min, prior to the IV maintenance infusion and before each oral dose;
VII. provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

In a preferred embodiment, the present invention involves a novel method of intravenously loading and maintaining dofetilide in a patient following coronary artery bypass surgery with the goal to reduce the risk of A F/AFL from developing post-surgery.

In an alternative preferred embodiment, the present invention involves a novel method of intravenously loading dofetilide in patients with arrhythmic storm following the implementation of an implantable defibrillator.

In another alternative embodiment, the method involves intravenously administering a loading dose in patients with arrhythmic storm following the insertion of an implantable defibrillator, followed by an intravenous maintenance infusion of dofetilide and then a switch-over to oral dosing for maintenance.

These and other objects, which will become apparent during the following detailed description, have been achieved by the inventors' discovery that intravenous dofetilide can be safely administered until a patient is capable of taking dofetilide orally and can then be safely switched to an oral dose.

Preferably, the pharmaceutical dofetilide iv composition according to an embodiment of the invention for use in the treatment of a patient in need thereof, wherein the risk of developing atrial fibrillation (AF) and/or atrial flutter (AFL) is reduced in the patient who has undergone coronary bypass surgery (CABS).

Preferably, the pharmaceutical dofetilide iv composition according to an embodiment for use in the treatment of a patient in need thereof, wherein an arrhythmic storm in the patient after implementation of an implantable defibrillator is terminated.

Preferably, the pharmaceutical dofetilide iv composition according to an embodiment for use in the treatment of a patient in need thereof, wherein atrial fibrillation (AF) or atrial flutter (AFL) is converted in the patient who presented with highly symptomatic AF or AFL.

Preferably, the pharmaceutical dofetilide iv composition according to an embodiment of the invention for use in the treatment of a patient in need thereof, wherein the patient is intravenously administered a loading dose of dofetilide of 450-500 μg of dofetilide.

Preferably, the pharmaceutical dofetilide iv composition according to an embodiment of the invention for use in the treatment of a patient in need thereof, wherein the patient is intravenously administered a maintenance infusion of dofetilide over 12 h of 100-500 μg dofetilide.

Preferably, the pharmaceutical dofetilide iv composition for use in the treatment of a patient in need thereof according to any of the previous embodiments, wherein the duration between the Cmax dofetilide concentration obtained after administration of the iv loading dose of dofetilide and the Cmax dofetilide concentration obtained after the first oral dose administration of dofetilide is between 14 and 18 hours.

These and other objects, which will become apparent during the following detailed description, have been achieved by the inventors' discovery that intravenous dofetilide can be used to treat arrhythmic storm in patients following the implementation of an implantable defibrillator.

### DETAILED DESCRIPTION OF THE INVENTION

All references cited herein are hereby incorporated in their entirety herein by reference.

### INTRAVENOUS DOFETILIDE TO REDUCE THE RISK OF DEVELOPING AF/AFL POST CORONARY BYPASS SURGERY

### Definitions

About is defined as +/−10% of the numerical value.

BID or bid or b.i.d. refers to twice-daily or once every 12 hours.

BP is blood pressure.

HR is heart rate.

IV means intravenous or intravenously.

### Dofetilide

Prior studies have reported that a single dose of dofetilide, following a 10 min. infusion of 1.5 μg/kg yielded a peak plasma concentration of 1.74 ng/mL. (Sedgwick et al, Br. J. Clin Pharmacol 1991:31:515-519 and Rasmussen et al J. Cardiovascular Pharmacology 20:1992, S96-101.) An infusion of 3.0 μg/mL resulted in a plasma concentration of 5.35 ng/mL. (Sedgwick et al. and Rasmussen et al.) Coz and associates (Clin. Pharmacology & Therapeutics, 1995; 57(5) 533-54) reported that a 500 μg oral dose of dofetilide yielded a plasma concentration Cmax of 1.9 ng/mL. Thus, if a single dose reaches 70% of predicted steady state, at steady state, one can estimate Cmax ss to be 2.7 ng/mL, if 500 μg/mL was administered twice daily for at least 5 doses. If an IV dose of 1.5 μg/kg is known to result in a peak level of 1.7 ng/mL, a dose of 2.4 μg/kg, assuming linear kinetics, would reach a peak concentration of 2.7 ng/mL, exposing the patient to the peak serum concentration predicted for steady state and thus the maximum QT_{c} prolongation. This would fully expose the patient to the potentially greatest arrhythmic risk in a short period of time, while monitored in hospital.

IV dofetilide kinetics are linear permitting a direct relationship between IV dose of dofetilide administered and serum concentration obtained. With IV administration one can avoid “overshoot” in serum concentration, avoiding excessive dofetilide blood levels and thus possible arrhythmias. The relationship between serum concentration and QT_{c} interval is well known, with a high degree of correlation.

### CABS: Coronary Bypass Surgery

It is generally preferred that the heart undergoing surgery is not exposed to unnecessary anti-arrhythmic drugs that could lead to adverse outcomes. It is also known that there is a 30-50% incidence of a CABS patient developing atrial fibrillation (AF) and/or atrial flutter (AFL) 3 to 5 days post-operative.

In view of the above, the present invention involves a novel method of loading dofetilide to maximize patient safety by carefully obtaining a minimally requisite effective drug blood concentration ensuring that there is no excessive QT prolongation that can result in cardiac repolarization abnormalities resulting in life threatening ventricular arrhythmias.

Thus, in an aspect, the present invention involves a novel method of reducing the risk of developing AF and/or AFL post CABS by administering dofetilide intravenously to patients who have undergone CABS. In another aspect, the method involves intravenously administering a loading dose of dofetilide and intravenously administering a maintenance dose of dofetilide. In another aspect, the method involves orally administering dofetilide BID. In another aspect, the method involves intravenously administering a loading dose and at least one maintenance dose of dofetilide with switch-over to oral dose maintenance.

Reducing the risk refers to reducing 30-50% risk of developing AF/AFL 3-5 post CABS surgery. Examples include reducing the risk to about 25, 20, 15, 10, 5, 4, 3, 2, 1, to 0% of developing AF and/or AFL.

In another aspect, the present invention involves a novel method of reducing the risk of developing atrial fibrillation (AF) and/or atrial flutter (AFL) in a patient who has undergone coronary bypass surgery (CABS), comprising:
a measuring the QT_{c} of the patient to establish a baseline QT_{c} and then measuring the QT_{c} about every 15-30 minutes thereafter;
b intravenously administering a loading dose of dofetilide to the patient who has undergone CABS, wherein:
   (A) the loading dose is about 450-500 μg of dofetilide; and,
   (B) the loading dose is administered over about 30-60 minutes;
c about 0-4 h after completion of the IV loading dose, intravenously administering a maintenance dose of dofetilide over about 12 h, the maintenance dose given being based on the creatinine clearance of the CABS patients as given in the following table;

| | | IV Maintenance Infusion of |
|---|---|---|
| Creatinine Clearance (CrCl) | | Dofetilide (over 12 h) |
| 60 | mL/min or more | 450-500 μg |
| 40-<60 | mL/min | 225-250 μg |
| 20-<40 | mL/min | 100-125 μg |
| <20 | mL/min | Dofetilide not indicated |

d once the patient has recovered enough from CABS to take dofetilide orally, stopping the IV maintenance dose.

In another aspect, the method, further comprises:
e about 2-6 h after stopping the maintenance dose, orally administering dofetilide every 12 h, the oral dose given being based on the creatinine clearance of the CABS patients as given in the following table;

| Creatinine Clearance (CrCl) | | Starting Oral Dose of Dofetilide |
|---|---|---|
| 60 | mL/min or more | 500 μg bid |
| 40-<60 | mL/min | 250 μg bid |
| 20-<40 | mL/min | 125 μg bid |
| <20 | mL/min | Dofetilide not indicated |

provided that if the patient's QTc increases by 15% over the baseline QTc or if the QTc is measured at >500 msec or >550 msec in patients with ventricular conduction abnormalities, the oral doses of dofetilide are reduced to 250 μg from 500 μg. 125 μg from 250 μg, or discontinued if originally 125 μg.

Typically, the QT_{c} is measured prior to administration of dofetilide to establish a baseline QT_{c} against which further QT_{c} measurements can be compared. The QT_{c} is typically measured about every 15, 20, 25, to 30 minutes. These measurements can be discontinued once the patient's medical staff is confident that the patient is stabilized on dofetilide. For example, the QT_{c} measurements can be discontinued after the maintenance dose of dofetilide is discontinued. Alternatively, the QT_{c} measurements can be discontinued after enough oral doses have been administered. The healthcare provided can determine when to discontinue the QT_{c} measurements. Examples of a sufficient number of oral doses include 1, 2, 3, 4, 5, 6, 7, 8, 9, 10, 11, 12, 13, 14, 15, 16, 17, 18, 19, to 20 oral doses.

In another aspect, the patient is monitored via electrocardiography to determine the patient's QT_{c}.

The IV loading dose is typically about 450-500 μg of dofetilide. Examples include about 450, 455, 460, 465, 470, 475, 480, 485, 490, 495, to 500 μg of dofetilide. Typically, the loading dose chosen is an amount that achieves the predicted maximal serum concentration from orally administering 500 μg dofetilide.

The IV loading dose is typically given over about 30-60 minutes. Examples include about 30, 31, 32, 33, 34, 35, 36, 37, 38, 39, 40, 30, 41, 42, 43, 44, 45, 46, 47, 48, 49, 50, 30, 51, 52, 53, 54, 55, 56, 57, 58, 59, to 60 minutes.

In another aspect, the IV maintenance dose is started upon completion of the loading dose. In another aspect, the IV maintenance dose is started about 0, 0.5, 1, 1.5, 2, 2.5, 3, 3.5, 4, 4.5, 5, 5.5, to 6 h after completion of the loading dose.

The IV maintenance dose, which typically is given for about 12 h, can be discontinued at any time. In another aspect, the maintenance dose is administered for about 1, 2, 3, 4, 5, 6, 7, 8, 9, 10, 11, 12, 13, 14, 15, 16, 17, 18, 19, 20, 21, 22, 23, to 24 h. Additional examples include about 1.5, 2, 2.5, 3, 3.5, to 4 days (or sometimes longer).

The IV maintenance dose can be discontinued if needed (e.g., an elevated QT_{c} is measured). This is an advantage of an IV versus an oral dose. The IV dose can be quickly stopped if the patient is having an adverse effect to the dofetilide.

The IV maintenance dose given is dependent upon the CrCl of the patient, as shown in the table below.

| Creatinine Clearance (CrCl) | | IV Maintenance Dofetilide Dose (12 h) |
|---|---|---|
| 60 | mL/min or more | 450-500 μg |
| 40-<60 | mL/min | 225-250 μg |
| 20-<40 | mL/min | 100-125 μg |
| <20 | mL/min | Dofetilide not indicated |

For a patient with a CrCl of ≥60 mL/min, the IV maintenance dose is typically about 450-500 μg of dofetilide and is typically given over about 12 h (but can vary as noted above). Examples include about 450, 455, 460, 465, 470, 475, 480, 485, 490, 495, to 500 p g of dofetilide. This equates to about 0.625-0.694 μg/min of dofetilide (450/720 to 500/720). In another aspect, the IV maintenance dose is about 0.6, 0.61, 0.62, 0.63, 0.64, 0.65, 0.66, 0.67, 0.68, 0.69, to 0.7 μg/min.

For a patient with a CrCl of 40-<60 mL/min, the IV maintenance dose is typically about 225-250 μg of dofetilide and is typically given over about 12 h (but can vary as noted above). Examples include about 225, 230, 235, 240, 245, to 250 μg of dofetilide. This equates to about 0.313-0.347 μg/min of dofetilide (225/720 to 250/720). In another aspect, the IV maintenance dose is about 0.3, 0.31, 0.32, 0.33, 0.34, to 0.35 μg/min.

For a patient with a CrCl of 20-<40 mL/min, the IV maintenance dose is typically about 100-125 μg of dofetilide and is typically given over about 12 h (but can vary as noted above). Examples include about 100, 105, 110, 115, 120, to 125 μg of dofetilide. This equates to about 0.139-0.174 μg/min of dofetilide (100/720 to 125/720). In another aspect, the IV maintenance dose is about 0.13, 0.14, 0.15, 0.16, 0.17, to 0.18 μg/min.

Since a patient is not awake during CABS and shortly after CABS, oral dofetilide cannot be administered. So, one advantage of the present invention is that a patient having undergone CABS can be loaded with dofetilide before the patient would normally be capable of taking oral dofetilide. Once a patient is determined to have recovered enough from CABS to take dofetilide orally, the dofetilide IV maintenance dose can be discontinued and a switch-over to oral dofetilide realized. It is the patient's medical staff (e.g., surgeon, doctor, nurse, etc.) that determines when a patient can take dofetilide orally. Typically, a patient can take oral medication when they are coherent. In some aspects, this will be when the patient awakens after surgery. In other aspects, the patient may require more time after waking up to be sufficiently coherent and able to swallow a pill.

In another aspect, the oral dose is started about 1, 2, 3, 4, 5, 6, 7, 8, 9, to 10 hours after the maintenance dose has been stopped. In another aspect, the oral dose is started about 3-6 hours after the maintenance dose has been stopped.

Oral dofetilide is available in capsule form in three sizes, 125, 250, and 500 μg. In another aspect, the patient is given dofetilide orally BID (once every 12 hours). Examples of these doses include 125, 250, 375 (e.g., 3×125 capsules or 125+250 capsules), and 500 μg.

The standard dose for patients having a creatinine clearance (CrCl)(or calculated GFR (glomerular filtration rate)) of ≥60 mL/min is 500 μg. However, per the table below, this dose is lowered if the patient's CRCL is <60 mL/min.

| Creatinine Clearance (CrCl) | | Starting Oral Dose of Dofetilide |
|---|---|---|
| 60 | mL/min or more | 500 μg bid |
| 40-<60 | mL/min | 250 μg bid |
| 20-<40 | mL/min | 125 μg bid |
| <20 | mL/min | Dofetilide not indicated |

The oral dose of dofetilide is also reduced if warranted by the patient's QT_{c}. For example, if the patient's QT_{c} increases by 15% over the baseline QT_{c} or if the QT_{c} is measured at >500 msec or >550 msec in patients with ventricular conduction abnormalities, the oral dose of dofetilide is reduced to 250 μg from 500 μg, or 125 μg from 250 μg, or discontinued if the original dose was 125 μg.

For a patient with a CrCl of ≥60 mL/min, the twice-daily oral doses of dofetilide are 500 μg. In this aspect, the oral doses are reduced to 250 μg if the patient's QT_{c} increased by 15% over baseline QT_{c} or if the QTc is measured at >500 msec or >550 msec if the patient has a ventricular conduction abnormality.

For a patient with a CrCl of 40-<60 mL/min, the twice-daily oral doses of dofetilide are 250 μg. In this aspect, the oral doses are reduced to 125 μg if the patient's QT_{c} increased by 15% over baseline QT_{c} or if the QTc is measured at >500 msec or >550 msec if the patient has a ventricular conduction abnormality.

For a patient with a CrCl of 20-<40 mL/min, the twice-daily oral doses of dofetilide are 125 μg. In this aspect, the treatment is discontinued if the patient's QT_{c} is increased by 15% over baseline QT_{c} or if the QT_{c} is measured at >500 msec or >550 msec if the patient has a ventricular conduction abnormality.

In an alternative aspect, a patient with a CrCl of 20-<40 mL/min is given 125 μg of dofetilide orally once daily. This once-daily regimen is selected based on the judgment of the patient's health care provider (e.g., physician, surgeon, doctor, etc.). In this aspect, the treatment is discontinued if the patient's QT_{c} is increased by 15% over baseline QT_{c} or if the QTc is measured at >500 msec or >550 msec if the patient has a ventricular conduction abnormality.

In another aspect, the patient has a CrCl of ≥60 mL/min, the IV maintenance dose is about 450-500 μg of dofetilide and is given over about 12 h and the twice-daily oral doses of dofetilide are 500 μg. In this aspect, the oral doses are reduced to 250 μg if the patient's QT_{c} increased by 15% over baseline QT_{c} or if the QTc is measured at >500 msec or >550 msec if the patient has a ventricular conduction abnormality.

In another aspect. the patient has a CrCl of 40-<60 mL/min, the IV maintenance dose is about 225-250 μg of dofetilide and is given over about 12 h and the twice-daily oral doses of dofetilide are 250 μg. In this aspect, the oral doses are reduced to 125 μg if the patient's QT_{c} increased by 15% over baseline QT_{c} or if the QTc is measured at >500 msec or >550 msec if the patient has a ventricular conduction abnormality.

In another aspect, the patient has a CrCl of 20-<40 mL/min, the IV maintenance dose is about 100-125 μg of dofetilide and is given over about 12 h and the twice-daily oral doses of dofetilide are 125 μg. In this aspect, the treatment is discontinued if the patient's QT_{c} is increased by 15% over baseline QT_{c} or if the QTc is measured at >500 msec or >550 msec if the patient has a ventricular conduction abnormality.

In an alternative aspect, the patient has a CrCl of 20-<40 mL/min, the IV maintenance dose is about 100-125 μg of dofetilide and is given over about 12 h, and the once-daily oral dose of dofetilide is 125 μg. In this aspect, the treatment is discontinued if the patient's QT_{c} is increased by 15% over baseline QT_{c} or if the QTc is measured at >500 msec or >550 msec if the patient has a ventricular conduction abnormality.

Suitable intravenous formulations are described in U.S. Pat. No. 11,364,213.

Examples of the concentration of a useful dofetilide intravenous solution includes about 1, 2, 3, 4, 5, 10, 15, 20, 25, 30, 35, 40, 45, 50, 55, 60, 65, 70, 75, 80, 85, 90, 95 to 100 μg/mL.

The present invention may be embodied in other specific forms without departing from the spirit or essential attributes thereof. This invention encompasses all combinations of aspects of the invention noted herein. It is understood that any and all embodiments of the present invention may be taken in conjunction with any other embodiment or embodiments to describe additional embodiments. It is also to be understood that each individual element of the embodiments is intended to be taken individually as its own independent embodiment. Furthermore, any element of an embodiment is meant to be combined with any and all other elements from any embodiment to describe an additional embodiment.

Other features of the invention will become apparent in the course of the following descriptions of exemplary embodiments that are given for illustration of the invention and are not intended to be limiting thereof.

### EXAMPLES

### Example 1

A 70 kg patient with a CrCl>90 mL/min presents after coronary bypass surgery. To decrease the possibility of AF post-op the patient is to receive a loading dose of dofetilide after the surgery is completed. The patient has an ECG continuously monitored. The patient is then subjected to the following treatment with dofetilide.
(A) Hour 0: Intravenous (IV) Loading Dose: 450 μg, infusion over 1 h measuring QT_{c}, HR, and BP every 15 minutes;
(B) Hour 1: IV Maintenance Dose: 450 μg, 12 h infusion, started at the end of the loading dose infusion; and,
(C) Hour 16: Oral Dose: 500 μg given orally every 12 hours (BID), started 3 h after termination of IV maintenance infusion.

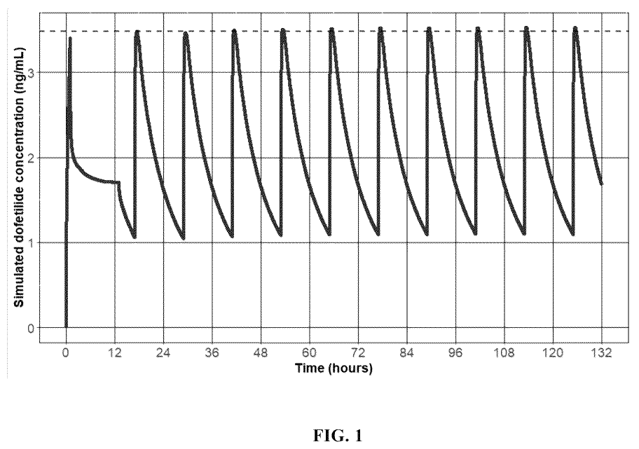

FIG. 1 shows the estimated blood dofetilide concentration obtained with the above described dosage regimen. This graph was obtained by modeling the above dosage regimen. The software packages NONMEM™ version 7.4 (ICON, Hanover, MD, USA) and MWpharm (Mediware, Prague, CZ) 6 were used for the Bayesian PK modeling. PsN7 (Dept. of Pharmacy, Uppsala University, Uppsala, Sweden) was used for automation procedures. R (version 3.5.1, The R Foundation for Statistical Computing) was used for data preparation, graphical analysis, linear regression analysis, and statistical summaries. R package ‘mrgsolve’ was used for simulations.

Step (A): the loading dose, which in this example is a 450 μg IV infusion of dofetilide over 1 h, is expected to achieve the predicted maximal serum concentration that one would expect from 500 μg-dofetilide orally. This would reach peak, if administered orally, after 6 doses twice daily of dofetilide. The peak concentration will typically be reached at termination of infusion.

QT_{c} would be measured every 15 mins.

Step (B): the IV maintenance dose of a 450 μg IV infusion of dofetilide over 12 h (0.625 μg/min) is initiated at the end of the 1 h loading IV. This dose can be maintained until the patient is awake and able to take dofetilide orally.

Once the patient can take dofetilide orally, the dofetilide maintenance IV is stopped. Starting about 3 h after stopping the maintenance IV, an oral dose of 500 μg of dofetilide is administered every 12 h (BID).

If the QT_{c} has increased by 15% over baseline QT_{c} or if a QT_{c}>500 msec is observed (550 msec in patients with ventricular conduction abnormalities), subsequent oral doses would be reduced to 250 μg BID (or lower if the original oral dose called for is lower, see below).

It is noted that if patients present with a lower than normal CrCl, the initial target concentration would be the same, but the oral (maintenance) dose administered would be lower, 250 μg or 125 μg BID (based on the chart below).

| Creatinine Clearance (CrCl) | | Oral Dose of Dofetilide |
|---|---|---|
| 60 | mL/min or more | 500 μg bid |
| 40-<60 | mL/min | 250 μg bid |
| 20-<40 | mL/min | 125 μg bid |
| <20 | mL/min | Dofetilide not indicated |

Further, in patients that show excessive QT_{c} prolongation at initial loading (>500 msec or >550 msec in patients with ventricular conduction abnormalities), the first oral dose would be reduced to 250 μg (or 125 μg if starting oral dose was 250 μg based on the above chart) and the peak concentration expected in 4 h with QT_{c} re-evaluated. In this way, a concentration projection from a dofetilide chronic oral dosing of 250 μg could be readily evaluated, with QT_{c} observation.

### Example 2

A 75 kg patient with a CrCl of 45 mL/min is undergoing CABGS presents after coronary bypass surgery. To decrease the possibility of AF post-op the patient is to receive a loading dose of dofetilide after the surgery is completed. The patient has an ECG continuously monitored. The patient is then subjected to the following treatment with dofetilide.
(A) Hour 0: IV Loading Dose: 450 μg, infusion over 1 h measuring QT_{c}, HR, and BP every 15 minutes.
(B) Hour 4: Maintenance Infusion: 225 μg infused over 12 hours started 3 hours after the end of the IV Loading Dose.
(C) Hour 21: Oral Dose initiated 250 μg given orally every 12 hours, started 5 hours after termination of IV maintenance infusion.

Numerous modifications and variations of the present invention are possible in light of the above teachings. It is therefore to be understood that within the scope of the appended claims, the invention may be practiced otherwise than as specifically described herein.

### EMBODIMENTS—A. PREVENTION OF AF(L) AFTER CABS

Embodiment 1: A method of reducing the risk of developing atrial fibrillation (AF) and/or atrial flutter (AFL) in a patient who has undergone coronary bypass surgery (CABS). comprising:
a measuring the QT_{c} of the patient to establish a baseline QT_{c} and then measuring the QT_{c} about every 15-30 minutes thereafter;
b intravenously administering a loading dose of dofetilide to the patient who has undergone CABS, wherein:
   (A) the loading dose is about 450-500 μg of dofetilide; and,
   (B) the loading dose is administered over about 30-60 minutes;
c about 0-4 h after completion of the IV loading dose, intravenously administering a maintenance dose of dofetilide over about 12 h, the maintenance dose given being based on the creatinine clearance (CrCl) of the CABS patient as given in the following table;

| CrCl | | IV Maintenance Dose | Oral Dose |
|---|---|---|---|
| 60 | mL/min or higher | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

d when the patient has recovered enough from CABS to take dofetilide orally, stopping the IV maintenance dose; and,
e about 2-6 h after stopping the IV maintenance dose, orally administering dofetilide every 12 h, the oral dose given being based on the CrCl of the CABS patient as given in the above table;
provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

Embodiment 2: The method of Embodiment 1, wherein the loading dose is about 450 μg.

Embodiment 3: The method of Embodiment 1, wherein the loading dose is about 460 μg.

Embodiment 4: The method of Embodiment 1, wherein the loading dose is about 470 μg.

Embodiment 5: The method of Embodiment 1, wherein the loading dose is about 480 μg.

Embodiment 6: The method of Embodiment 1, wherein the loading dose is about 490 μg.

Embodiment 7: The method of Embodiment 1, wherein the loading dose is about 500 μg.

Embodiment 8: The method of Embodiment 1, wherein the loading dose is administered over about 30 minutes.

Embodiment 9: The method of Embodiment 1, wherein the loading dose is administered over about 40 minutes.

Embodiment 10: The method of Embodiment 1, wherein the loading dose is administered over about 50 minutes.

Embodiment 11: The method of Embodiment 1, wherein the loading dose is administered over about 60 minutes.

Embodiment 12: The method of Embodiment 1, wherein the maintenance dose is started about 0 h after completion of the loading dose.

Embodiment 13: The method of Embodiment 1, wherein the maintenance dose is started about 1 h after completion of the loading dose.

Embodiment 14: The method of Embodiment 1, wherein the maintenance dose is started about 2 h after completion of the loading dose.

Embodiment 15: The method of Embodiment 1, wherein the maintenance dose is started about 3 h after completion of the loading dose.

Embodiment 16: The method of Embodiment 1, wherein the maintenance dose is started about 4 h after completion of the loading dose.

Embodiment 17: The method of Embodiment 1, wherein the patient has a CrCl of >60 mL/min, the IV maintenance dose is about 450-500 μg given over about 12 h and the oral doses are 500 μg.

Embodiment 18: The method of Embodiment 17, wherein the oral doses are reduced to 250 μg due to a QTc that increased by 15% over baseline QTc or if the QTc is measured at >500 msec or >550 msec if the patient has a ventricular conduction abnormality.

Embodiment 19: The method of Embodiment 1, wherein the patient has a CrCl of 40-<60 mL/min, the IV maintenance dose is about 225-250 μg given over about 12 h and the oral doses are 250 μg.

Embodiment 20: The method of Embodiment 19, wherein the oral doses are reduced to 125 μg due to a QTc that increased by 15% over baseline QTc or if the QTc is measured at >500 msec or >550 msec if the patient has a ventricular conduction abnormality.

Embodiment 21: The method of Embodiment 1, wherein the patient has a CrCl of 20-<40 mL/min, the IV maintenance dose is about 100-125 μg given over about 12 h and the oral doses are 125 μg.

Embodiment 22: The method of Embodiment 21, wherein the oral doses are discontinued due to a QTc that increased by 15% over baseline QTc or if the QTc is measured at >500 msec is observed or >550 msec if the patient has a ventricular conduction abnormality.

Embodiment 23: A method of reducing the risk of developing atrial fibrillation (AF) and/or atrial flutter (AFL) in a patient who has undergone coronary bypass surgery (CABS) and who has a creatinine clearance (CrCl) of 20-<40 mL/min, comprising:
a measuring the QT_{c} of the patient to establish a baseline QT_{c} and then measuring the QT_{c} about every 15-30 minutes thereafter;
b intravenously administering a loading dose of dofetilide to the patient who has undergone CABS, wherein:
   (A) the loading dose is about 450-500 μg of dofetilide; and,
   (B) the loading dose is administered over about 30-60 minutes;
c about 0-4 h after completion of the IV loading dose, intravenously administering a 100-125 μg maintenance dose of dofetilide over about 12 h, this maintenance dose being based on the CrCl of the CABS patient;
d once the patient has recovered enough from CABS to take dofetilide orally, stopping the IV maintenance dose; and,
e about 2-6 h after stopping the IV maintenance dose, orally administering 125 μg of dofetilide every 24 h;
provided that if the patient's QTc increases by 15% over the baseline QTc or if the QTc is measured at >500 msec or >550 msec if the patient has a ventricular conduction abnormality, the oral dose is discontinued.

### FURTHER EMBODIMENTS—A. PREVENTION OF AF(L) AFTER CABS

Embodiment 1: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 450-500 μg dofetilide to those patients having a creatine clearance of 60 mL/min or higher;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec;
and wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 2: The method of embodiment 1, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 3: The method of embodiment 1, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 4: The method of embodiment 3, wherein the patient's medical staff determines when the sufficient number of oral dosages have been administered.

Embodiment 5: The method of embodiment 4, wherein the patient's medical staff is the patient's surgeon, doctor, and/or nurse.

Embodiment 6: The method of embodiment 1, wherein the loading dose is about 450-500 μg dofetilide.

Embodiment 7: The method of embodiment 1, wherein the 1-3 hours after completion of the loading dose, a maintenance dose (“the IV maintenance dose”) of 450-500 μg dofetilide is administered to those patients having a creatine clearance of 60 mL/min or higher.

Embodiment 8: The method of embodiment 1, wherein the IV maintenance dose is about 450-500 μg dofetilide

Embodiment 9: The method of embodiment 1, wherein the creatine clearance is 60 mL/min or higher.

Embodiment 10: The method of embodiment 1, wherein the IV maintenance dose is stopped after 2-6 hours.

Embodiment 11: The method of embodiment 1, further comprising measuring the patient's creatine clearance as an approximation of the glomerular filtration rate (GFR), prior to administering the IV maintenance dose, to determine the amount of dofetilide indicated for the IV maintenance dose.

Embodiment 12: The method of embodiment 1, further comprising measuring the patient's creatine clearance as an approximation of the glomerular filtration rate (GFR), prior to orally administering dofetilide, to determine the amount of dofetilide indicated for the oral dose.

Embodiment 13: The method of embodiment 1, wherein the patient has sufficiently recovered from CABS and is orally administered dofetilide when the patient is awake and coherent after surgery, which is determined by the patient's medical staff.

Embodiment 14: The method of embodiment 13, wherein the patient's medical staff is the patient's surgeon, doctor, and/or nurse.

Embodiment 15: The method of embodiment 1, wherein the intravenous loading dose is administered over about 40-50 minutes.

Embodiment 16: The method of embodiment 1, wherein the IV maintenance dose is administered over 12 hours.

Embodiment 17: The method of embodiment 1, wherein the dofetilide is fully loaded in less than three days.

Embodiment 18: The method of embodiment 17, wherein the dofetilide is fully loaded when it reaches steady state concentration in the blood.

Embodiment 19: The method of embodiment 1, wherein the intravenous dofetilide is administered in a first loading dose and an ongoing IV maintenance dose.

Embodiment 20: The method of embodiment 1, wherein intravenous dofetilide administration prevents possible arrythmias by avoiding excessive dofetilide blood levels.

Embodiment 21: The method of embodiment 1, wherein the patient can be loaded with dofetilide by intravenous administration before the patient would be coherent and awake after surgery and capable of taking oral dofetilide.

Embodiment 22: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 450-500 μg dofetilide to those patients having a creatine clearance of 60 mL/min or higher;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QT_{c} of 15% over baseline, those patients having a QT_{c} of >500 msec, or for those patients with a ventricular conduction abnormality having a QT_{c} of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 22: The method of embodiment 22, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 24: The method of embodiment 22, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 25: The method of embodiment 24, wherein the patient's medical staff determines when the sufficient number of oral dosages have been administered.

Embodiment 26: The method of embodiment 25, wherein the patient's medical staff is the patient's surgeon, doctor, and/or nurse.

Embodiment 27: The method of embodiment 22, wherein the loading dose is 450-500 μg dofetilide.

Embodiment 28: The method of embodiment 22, wherein 1-3 hours after completion of the loading dose, a maintenance dose (“the IV maintenance dose”) of 450-500 μg dofetilide is administered to those patients having a creatine clearance of 60 mL/min or higher.

Embodiment 29: The method of embodiment 22, wherein the IV maintenance dose is 450-500 μg dofetilide.

Embodiment 30: The method of embodiment 22, wherein the creatine clearance is 60 mL/min or higher.

Embodiment 31: The method of embodiment 22, wherein the IV maintenance dose is stopped after 3-5 hours.

Embodiment 32: The method of embodiment 22, further comprising measuring the patient's creatine clearance as an approximation of the glomerular filtration rate (GFR), prior to administering the IV maintenance dose, to determine the amount of dofetilide indicated for the IV maintenance dose.

Embodiment 33: The method of embodiment 22, further comprising measuring the patient's creatine clearance as an approximation of the glomerular filtration rate (GFR), prior to orally administering dofetilide, to determine the amount of dofetilide indicated for the oral dose.

Embodiment 34: The method of embodiment 22, wherein the patient has sufficiently recovered from CABS and is orally administered dofetilide when the patient is awake and coherent after surgery, which is determined by the patient's medical staff.

Embodiment 35: The method of embodiment 34, wherein the patient's medical staff is the patient's surgeon, doctor, and/or nurse.

Embodiment 36: The method of embodiment 22, wherein the intravenous loading dose is administered over about 30-60 minutes.

Embodiment 37: The method of embodiment 22, wherein the IV maintenance dose is administered over about 12 hours.

Embodiment 38: The method of embodiment 22, wherein the dofetilide is fully loaded in less than three days.

Embodiment 39: The method of embodiment 38, wherein the dofetilide is fully loaded when it reaches steady state concentration in the blood.

Embodiment 40: The method of embodiment 22, wherein the intravenous dofetilide is administered in a first loading dose and an ongoing IV maintenance dose.

Embodiment 41: The method of embodiment 22, wherein intravenous dofetilide administration prevents possible arrythmias by avoiding excessive dofetilide blood levels.

Embodiment 42: The method of embodiment 22, wherein the patient can be loaded with dofetilide by intravenous administration before the patient would be coherent and awake after surgery and capable of taking oral dofetilide.

Embodiment 43: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 450-500 μg dofetilide to those patients having a creatine clearance of 60 mL/min or higher;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 125 μg dofetilide every 12 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 44: The method of embodiment 43, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 45: The method of embodiment 43, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 46: The method of embodiment 45, wherein the patient's medical staff determines when the sufficient number of oral dosages have been administered.

Embodiment 47: The method of embodiment 46, wherein the patient's medical staff is the patient's surgeon, doctor, and/or nurse.

Embodiment 48: The method of embodiment 43, wherein the loading dose is about 450-500 μg dofetilide.

Embodiment 49: The method of embodiment 43, wherein 1-3 hours after completion of the loading dose, a maintenance dose (“the IV maintenance dose”) of 450-500 μg dofetilide is administered to those patients having a creatine clearance of 60 mL/min or higher.

Embodiment 50: The method of embodiment 43, wherein the IV maintenance dose of about 450-500 μg dofetilide.

Embodiment 51: The method of embodiment 43, wherein the creatine clearance is 60 mL/min or higher.

Embodiment 52: The method of embodiment 43, wherein the 1-3 hours after completion of the loading dose, a maintenance dose (“the IV maintenance dose”) of 450-500 μg dofetilide is administered to those patients having a creatine clearance of 60 mL/min or higher.

Embodiment 53: The method of embodiment 43, further comprising measuring the patient's creatine clearance as an approximation of the glomerular filtration rate (GFR), prior to administering the IV maintenance dose, to determine the amount of dofetilide indicated for the IV maintenance dose.

Embodiment 54: The method of embodiment 43, further comprising measuring the patient's creatine clearance as an approximation of the glomerular filtration rate (GFR), prior to orally administering dofetilide, to determine the amount of dofetilide indicated for the oral dose.

Embodiment 55: The method of embodiment 43, wherein the patient has sufficiently recovered from CABS and is orally administered dofetilide when the patient is awake and coherent after surgery, which is determined by the patient's medical staff.

Embodiment 56: The method of embodiment 55, wherein the patient's medical staff is the patient's surgeon, doctor, and/or nurse.

Embodiment 57: The method of embodiment 43, wherein the intravenous loading dose is administered over about 30-60 minutes.

Embodiment 58: The method of embodiment 43, wherein the IV maintenance dose is administered over about 12 hours.

Embodiment 59: The method of embodiment 43, wherein the dofetilide is fully loaded in less than three days.

Embodiment 60: The method of embodiment 59, wherein the dofetilide is fully loaded when it reaches steady state concentration in the blood.

Embodiment 61: The method of embodiment 43, wherein the intravenous dofetilide is administered in a first loading dose and an ongoing IV maintenance dose.

Embodiment 62: The method of embodiment 43, wherein intravenous dofetilide administration prevents possible arrythmias by avoiding excessive dofetilide blood levels.

Embodiment 63: The method of embodiment 43, wherein the patient can be loaded with dofetilide by intravenous administration before the patient would be coherent and awake after surgery and capable of taking oral dofetilide.

Embodiment 64: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 225-250 μg dofetilide to those patients having a creatine clearance of 40-<60 mL/min;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 65: The method of embodiment 64, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 66: The method of embodiment 64, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 67: The method of embodiment 66, wherein the patient's medical staff determines when the sufficient number of oral dosages have been administered.

Embodiment 68: The method of embodiment 67, wherein the patient's medical staff is the patient's surgeon, doctor, and/or nurse.

Embodiment 69: The method of embodiment 66, wherein the loading dose is 450-500 μg dofetilide.

Embodiment 70: The method of embodiment 66, wherein 1-3 hours after completion of the loading dose, a maintenance dose (“the IV maintenance dose”) of 450-500 μg dofetilide is administered to those patients having a creatine clearance of 60 mL/min or higher.

Embodiment 71: The method of embodiment 66, wherein the IV maintenance dose is 225-250 μg dofetilide.

Embodiment 72: The method of embodiment 66, wherein the creatine clearance is 60 mL/min or higher.

Embodiment 73: The method of embodiment 66, wherein 1-3 hours after completion of the loading dose, a maintenance dose (“the IV maintenance dose”) of 450-500 μg dofetilide is administered to those patients having a creatine clearance of 60 mL/min or higher.

Embodiment 74: The method of embodiment 66, further comprising measuring the patient's creatine clearance as an approximation of the glomerular filtration rate (GFR), prior to administering the IV maintenance dose, to determine the amount of dofetilide indicated for the IV maintenance dose.

Embodiment 75: The method of embodiment 66, further comprising measuring the patient's creatine clearance as an approximation of the glomerular filtration rate (GFR), prior to orally administering dofetilide, to determine the amount of dofetilide indicated for the oral dose.

Embodiment 76: The method of embodiment 66, wherein the patient has sufficiently recovered from CABS and is orally administered dofetilide when the patient is awake and coherent after surgery, which is determined by the patient's medical staff.

Embodiment 77: The method of embodiment 76, wherein the patient's medical staff is the patient's surgeon, doctor, and/or nurse.

Embodiment 78: The method of embodiment 66, wherein the intravenous loading dose is administered over about 30-60 minutes.

Embodiment 79: The method of embodiment 66, wherein the IV maintenance dose is administered over about 12 hours.

Embodiment 80: The method of embodiment 66, wherein the dofetilide is fully loaded in less than three days.

Embodiment 81: The method of embodiment 80, wherein the dofetilide is fully loaded when it reaches steady state concentration in the blood.

Embodiment 82: The method of embodiment 66, wherein the intravenous dofetilide is administered in a first loading dose and an ongoing IV maintenance dose.

Embodiment 83: The method of embodiment 66, wherein intravenous dofetilide administration prevents possible arrythmias by avoiding excessive dofetilide blood levels.

Embodiment 84: The method of embodiment 66, wherein the patient can be loaded with dofetilide by intravenous administration before the patient would be coherent and awake after surgery and capable of taking oral dofetilide.

Embodiment 85: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 225-250 μg dofetilide to those patients having a creatine clearance of 40-<60 mL/min;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 86: The method of embodiment 85, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 87: The method of embodiment 85, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 88: The method of embodiment 87, wherein the patient's medical staff determines when the sufficient number of oral dosages have been administered.

Embodiment 89: The method of embodiment 88, wherein the patient's medical staff is the patient's surgeon, doctor, and/or nurse.

Embodiment 90: The method of embodiment 85, wherein the loading dose is 450-500 μg dofetilide.

Embodiment 91: The method of embodiment 85, wherein 1-3 hours after completion of the loading dose, a maintenance dose (“the IV maintenance dose”) of 450-500 μg dofetilide is administered to those patients having a creatine clearance of 60 mL/min or higher.

Embodiment 92: The method of embodiment 85, wherein the IV maintenance dose is 225-250 μg dofetilide.

Embodiment 93: The method of embodiment 85, wherein 1-3 hours after completion of the loading dose, a maintenance dose (“the IV maintenance dose”) of 450-500 μg dofetilide is administered to those patients having a creatine clearance of 60 mL/min or higher.

Embodiment 94: The method of embodiment 85, further comprising measuring the patient's creatine clearance as an approximation of the glomerular filtration rate (GFR), prior to administering the IV maintenance dose, to determine the amount of dofetilide indicated for the IV maintenance dose.

Embodiment 95: The method of embodiment 85, further comprising measuring the patient's creatine clearance as an approximation of the glomerular filtration rate (GFR), prior to orally administering dofetilide, to determine the amount of dofetilide indicated for the oral dose.

Embodiment 96: The method of embodiment 85, wherein the patient has sufficiently recovered from CABS and is orally administered dofetilide when the patient is awake and coherent after surgery, which is determined by the patient's medical staff.

Embodiment 97: The method of embodiment 96, wherein the patient's medical staff is the patient's surgeon, doctor, and/or nurse.

Embodiment 98: The method of embodiment 85, wherein the intravenous loading dose is administered over about 30-60 minutes.

Embodiment 99: The method of embodiment 85, wherein the IV maintenance dose is administered over about 12 hours.

Embodiment 100: The method of embodiment 85, wherein the dofetilide is fully loaded in less than three days.

Embodiment 101: The method of embodiment 100, wherein the dofetilide is fully loaded when it reaches steady state concentration in the blood.

Embodiment 102: The method of embodiment 85, wherein the intravenous dofetilide is administered in a first loading dose and an ongoing IV maintenance dose.

Embodiment 103: The method of embodiment 85, wherein intravenous dofetilide administration prevents possible arrythmias by avoiding excessive dofetilide blood levels.

Embodiment 104: The method of embodiment 85, wherein the patient can be loaded with dofetilide by intravenous administration before the patient would be coherent and awake after surgery and capable of taking oral dofetilide.

Embodiment 105: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 225-250 μg dofetilide to those patients having a creatine clearance of 40-<60 mL/min;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 125 μg dofetilide every 12 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 106: The method of embodiment 105, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 107: The method of embodiment 105, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 108: The method of embodiment 107, wherein the patient's medical staff determines when the sufficient number of oral dosages have been administered.

Embodiment 109: The method of embodiment 108, wherein the patient's medical staff is the patient's surgeon, doctor, and/or nurse.

Embodiment 110: The method of embodiment 105, wherein the loading dose is 450-500 μg dofetilide.

Embodiment 111: The method of embodiment 105, wherein 1-3 hours after completion of the loading dose, a maintenance dose (“the IV maintenance dose”) of 450-500 pg dofetilide is administered to those patients having a creatine clearance of 60 mL/min or higher.

Embodiment 112: The method of embodiment 105, wherein the IV maintenance dose is 225-250 μg dofetilide.

Embodiment 113: The method of embodiment 105, wherein 1-3 hours after completion of the loading dose, a maintenance dose (“the IV maintenance dose”) of 450-500 μg dofetilide is administered to those patients having a creatine clearance of 60 mL/min or higher.

Embodiment 114: The method of embodiment 105, further comprising measuring the patient's creatine clearance as an approximation of the glomerular filtration rate (GFR), prior to administering the IV maintenance dose, to determine the amount of dofetilide indicated for the IV maintenance dose.

Embodiment 115: The method of embodiment 105, further comprising measuring the patient's creatine clearance as an approximation of the glomerular filtration rate (GFR), prior to orally administering dofetilide, to determine the amount of dofetilide indicated for the oral dose.

Embodiment 116: The method of embodiment 105, wherein the patient has sufficiently recovered from CABS and is orally administered dofetilide when the patient is awake and coherent after surgery, which is determined by the patient's medical staff.

Embodiment 117: The method of embodiment 116, wherein the patient's medical staff is the patient's surgeon, doctor, and/or nurse.

Embodiment 118: The method of embodiment 105, wherein the intravenous loading dose is administered over about 30-60 minutes.

Embodiment 119: The method of embodiment 105, wherein the IV maintenance dose is administered over about 12 hours.

Embodiment 120: The method of embodiment 105, wherein the dofetilide is fully loaded in less than three days.

Embodiment 121: The method of embodiment 120, wherein the dofetilide is fully loaded when it reaches steady state concentration in the blood.

Embodiment 122: The method of embodiment 105, wherein the intravenous dofetilide is administered in a first loading dose and an ongoing IV maintenance dose.

Embodiment 123: The method of embodiment 105, wherein intravenous dofetilide administration prevents possible arrythmias by avoiding excessive dofetilide blood levels.

Embodiment 124: The method of embodiment 105, wherein the patient can be loaded with dofetilide by intravenous administration before the patient would be coherent and awake after surgery and capable of taking oral dofetilide.

Embodiment 125: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 100-125 μg dofetilide to those patients having a creatine clearance of 20-<40 mL/min;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 126: The method of embodiment 125, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 127: The method of embodiment 125, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 128: The method of embodiment 127, wherein the patient's medical staff determines when the sufficient number of oral dosages have been administered.

Embodiment 129: The method of embodiment 128, wherein the patient's medical staff is the patient's surgeon, doctor, and/or nurse.

Embodiment 130: The method of embodiment 125, wherein the loading dose is 450-500 μg dofetilide.

Embodiment 131: The method of embodiment 125, wherein 1-3 hours after completion of the loading dose, a maintenance dose (“the IV maintenance dose”) of 450-500 μg dofetilide is administered to those patients having a creatine clearance of 60 mL/min or higher.

Embodiment 132: The method of embodiment 125, wherein the IV maintenance dose is 100-125 μg dofetilide.

Embodiment 133: The method of embodiment 125, wherein the creatine clearance is 60 mL/min or higher.

Embodiment 134: The method of embodiment 125, 1. wherein 3-5 hours after discontinuing the IV maintenance dose, 500 μg dofetilide is orally administered every 12 hours to those patients having a creatine clearance of 60 mL/min or higher.

Embodiment 135: The method of embodiment 125, further comprising measuring the patient's creatine clearance as an approximation of the glomerular filtration rate (GFR), prior to administering the IV maintenance dose, to determine the amount of dofetilide indicated for the IV maintenance dose.

Embodiment 136: The method of embodiment 125, further comprising measuring the patient's creatine clearance as an approximation of the glomerular filtration rate (GFR), prior to orally administering dofetilide, to determine the amount of dofetilide indicated for the oral dose.

Embodiment 137: The method of embodiment 125, wherein the patient has sufficiently recovered from CABS and is orally administered dofetilide when the patient is awake and coherent after surgery, which is determined by the patient's medical staff.

Embodiment 138: The method of embodiment 137, wherein the patient's medical staff is the patient's surgeon, doctor, and/or nurse.

Embodiment 139: The method of embodiment 125, wherein the intravenous loading dose is administered over about 30-60 minutes.

Embodiment 140: The method of embodiment 125, wherein the IV maintenance dose is administered over about 12 hours.

Embodiment 141: The method of embodiment 125, wherein the dofetilide is fully loaded in less than three days.

Embodiment 142: The method of embodiment 141, wherein the dofetilide is fully loaded when it reaches steady state concentration in the blood.

Embodiment 143: The method of embodiment 125, wherein the intravenous dofetilide is administered in a first loading dose and an ongoing IV maintenance dose.

Embodiment 144: The method of embodiment 125, wherein intravenous dofetilide administration prevents possible arrythmias by avoiding excessive dofetilide blood levels.

Embodiment 145: The method of embodiment 125, wherein the patient can be loaded with dofetilide by intravenous administration before the patient would be coherent and awake after surgery and capable of taking oral dofetilide.

Embodiment 146: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 100-125 μg dofetilide to those patients having a creatine clearance of 20-<40 mL/min;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 147: The method of embodiment 146, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 148: The method of embodiment 146, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 149: The method of embodiment 148, wherein the patient's medical staff determines when the sufficient number of oral dosages have been administered.

Embodiment 150: The method of embodiment 149, wherein the patient's medical staff is the patient's surgeon, doctor, and/or nurse.

Embodiment 151: The method of embodiment 146, wherein the loading dose is 450-500 μg dofetilide.

Embodiment 152: The method of embodiment 146, wherein 1-3 hours after completion of the loading dose, a maintenance dose (“the IV maintenance dose”) of 450-500 μg dofetilide is administered to those patients having a creatine clearance of 60 mL/min or higher.

Embodiment 153: The method of embodiment 146, wherein the IV maintenance dose is 100-125 μg dofetilide.

Embodiment 154: The method of embodiment 146, 1. wherein the IV maintenance dose is stopped after 3-5 hours. the IV maintenance dose.

Embodiment 155: The method of embodiment 146, further comprising measuring the patient's creatine clearance as an approximation of the glomerular filtration rate (GFR), prior to administering the IV maintenance dose, to determine the amount of dofetilide indicated for the IV maintenance dose.

Embodiment 156: The method of embodiment 146, further comprising measuring the patient's creatine clearance as an approximation of the glomerular filtration rate (GFR), prior to orally administering dofetilide, to determine the amount of dofetilide indicated for the oral dose.

Embodiment 157: The method of embodiment 146, wherein the patient has sufficiently recovered from CABS and is orally administered dofetilide when the patient is awake and coherent after surgery, which is determined by the patient's medical staff.

Embodiment 158: The method of embodiment 157, wherein the patient's medical staff is the patient's surgeon, doctor, and/or nurse.

Embodiment 159: The method of embodiment 146, wherein the intravenous loading dose is administered over about 30-60 minutes.

Embodiment 160: The method of embodiment 146, wherein the IV maintenance dose is administered over about 12 hours.

Embodiment 161: The method of embodiment 146, wherein the dofetilide is fully loaded in less than three days.

Embodiment 162: The method of embodiment 161, wherein the dofetilide is fully loaded when it reaches steady state concentration in the blood.

Embodiment 163: The method of embodiment 146, wherein the intravenous dofetilide is administered in a first loading dose and an ongoing IV maintenance dose.

Embodiment 164: The method of embodiment 146, wherein intravenous dofetilide administration prevents possible arrythmias by avoiding excessive dofetilide blood levels.

Embodiment 165: The method of embodiment 146, wherein the patient can be loaded with dofetilide by intravenous administration before the patient would be coherent and awake after surgery and capable of taking oral dofetilide.

Embodiment 166: A method of treating patients who have undergone coronary bypass surgery (CABS), comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 100-125 μg dofetilide to those patients having a creatine clearance of 20-<40 mL/min;
c. administering the IV maintenance dose over about 12 hours;
d. discontinuing the IV maintenance dose for those patients who have sufficiently recovered from CABS; and
e. about 2-6 hours after discontinuing the IV maintenance dose, orally administering 125 μg dofetilide every 12 or every 24 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 167: The method of embodiment 166, which is a method of reducing the risk of developing atrial fibrillation (AF) and/or atrial flutter (AFL) in a patient who has undergone coronary bypass surgery (CABS), wherein reducing the risk refers to reducing 30-50% risk of developing AF/AFL in the three to five days directly following CABS surgery.

Embodiment 168: The method of embodiment 166, further comprising measuring the patient's QTc prior to intravenously administering the loading dose of dofetilide, thereafter measuring the QTc every 15-30 minutes, until the discontinuation of the IV maintenance dose of dofetilide or after a sufficient number of oral doses have been administered.

Embodiment 169: The method of embodiment 168, wherein the patient's medical staff determines when the sufficient number of oral dosages have been administered.

Embodiment 170: The method of embodiment 169, wherein the patient's medical staff is the patient's surgeon, doctor, and/or nurse.

Embodiment 171: The method of embodiment 166, wherein the loading dose is 450-500 μg dofetilide.

Embodiment 172: The method of embodiment 166, wherein 1-3 hours after completion of the loading dose, a maintenance dose (“the IV maintenance dose”) of 450-500 μg dofetilide is administered to those patients having a creatine clearance of 60 mL/min or higher.

Embodiment 173: The method of embodiment 166, wherein the IV maintenance dose of about 100-125 μg dofetilide.

Embodiment 174: The method of embodiment 166, 1. wherein the IV maintenance dose is stopped after 3-5 hours. the IV maintenance dose.

Embodiment 175: The method of embodiment 166, further comprising measuring the patient's creatine clearance as an approximation of the glomerular filtration rate (GFR), prior to administering the IV maintenance dose, to determine the amount of dofetilide indicated for the IV maintenance dose.

Embodiment 176: The method of embodiment 166, further comprising measuring the patient's creatine clearance as an approximation of the glomerular filtration rate (GFR), prior to orally administering dofetilide, to determine the amount of dofetilide indicated for the oral dose.

Embodiment 177: The method of embodiment 166, wherein the patient has sufficiently recovered from CABS and is orally administered dofetilide when the patient is awake and coherent after surgery, which is determined by the patient's medical staff.

Embodiment 178: The method of embodiment 177, wherein the patient's medical staff is the patient's surgeon, doctor, and/or nurse.

Embodiment 179: The method of embodiment 166, wherein the intravenous loading dose is administered over about 30-60 minutes.

Embodiment 180: The method of embodiment 166, wherein the IV maintenance dose is administered over about 12 hours

Embodiment 181: The method of embodiment 166, wherein the dofetilide is fully loaded in less than three days.

Embodiment 182: The method of embodiment 181, wherein the dofetilide is fully loaded when it reaches steady state concentration in the blood.

Embodiment 183: The method of embodiment 166, wherein the intravenous dofetilide is administered in a first loading dose and an ongoing IV maintenance dose.

Embodiment 184: The method of embodiment 166, wherein intravenous dofetilide administration prevents possible arrythmias by avoiding excessive dofetilide blood levels.

Embodiment 185: The method of embodiment 166, wherein the patient can be loaded with dofetilide by intravenous administration before the patient would be coherent and awake after surgery and capable of taking oral dofetilide.

### INTRAVENOUS DOFETILIDE TO TERMINATE ARRHYTHMIC STORM FOLLOWING IMPLANTATION OF A CARDIAC DEFIBRILLATOR

All references cited herein are hereby incorporated in their entirety herein by reference.

### Definitions

About is defined as +/−10% of the numerical value.

Arrhythmic storm (AS) is defined as three or more episodes of sustained ventricular tachycardia (VT) or ventricular fibrillation (VF) occurring during a 24 h span.

BID or bid or b.i.d. refers to twice-daily or once every 12 hours.

BP is blood pressure.

HR is heart rate.

IV means intravenous or intravenously.

### Dofetilide

Prior studies have reported that a single dose of dofetilide, following a 10 min. infusion of 1.5 μg/kg yielded a peak plasma concentration of 1.74 ng/mL. (Sedgwick et al, Br. J. Clin Pharmacol 1991:31:515-519 and Rasmussen et al J. Cardiovascular Pharmacology 20:1992, S96-101.) An infusion of 3.0 μg/mL resulted in a plasma concentration of 5.35 ng/mL. (Sedgwick et al. and Rasmussen et al.) Coz and associates (Clin. Pharmacology & Therapeutics, 1995; 57(5) 533-54) reported that a 500 μg oral dose of dofetilide yielded a plasma concentration Cmax of 1.9 ng/mL. Thus, if a single dose reaches 70% of predicted steady state, at steady state, one can estimate Cmax ss to be 2.7 ng/mL, if 500 μg/mL was administered twice daily for at least 5 doses. If an IV dose of 1.5 μg/kg is known to result in a peak level of 1.7 ng/mL, a dose of 2.4 μg/kg, assuming linear kinetics, would reach a peak concentration of 2.7 ng/mL, exposing the patient to the peak serum concentration predicted for steady state and thus the maximum QT_{c} prolongation. This would fully expose the patient to the potentially greatest arrhythmic risk in a short period of time, while monitored in hospital.

IV dofetilide kinetics are linear permitting a direct relationship between IV dose of dofetilide administered and serum concentration obtained. With IV administration one can avoid “overshoot” in serum concentration, avoiding excessive dofetilide blood levels and thus possible arrhythmias. The relationship between serum concentration and QT_{c} interval is well known, with a high degree of correlation.

### Arrhythmic Storm

In view of the above, the invention involves a novel method of loading dofetilide to maximize patient safety by carefully obtaining a requisite effective drug blood concentration and determining that there is no excessive QT prolongation that can result in cardiac repolarization abnormalities resulting in life threatening ventricular arrhythmias at that concentration of dofetilide.

Thus, in an aspect, the invention involves a novel method of terminating arrhythmic storm in a patient following implementation of an implantable defibrillator. In another aspect, the method involves intravenously administering a loading dose and maintenance infusion of dofetilide. In another aspect, the method involves orally administering dofetilide BID. In another aspect. the method involves intravenously administering a loading dose and at least one maintenance infusion of dofetilide with switch-over to oral dosing.

In another aspect, the invention involves a novel method of terminating arrhythmic storm in a patient after implementation of an implantable defibrillator, comprising:
f intravenously administering a loading dose of dofetilide to the patient who presents with arrhythmic storm after implementation of an implantable defibrillator, wherein:
   (A) the loading dose is about 450-500 μg of dofetilide; and,
   (B) the loading dose is administered over about 30-60 minutes;
g about 0-4 h after completion of the IV loading dose, intravenously administering a maintenance infusion of dofetilide over about 12 h, the maintenance infusion given being based on the creatinine clearance (CrCl) of the patient as given in the following table;

| | | IV Maintenance Infusion | Oral Dose |
|---|---|---|---|
| CrCl | | (over 12 hrs) | (every 12 hrs) |
| ≥60 | mL/min | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

h once the patient has recovered enough from the termination of the arrhythmic storm to take dofetilide orally, stopping the IV maintenance infusion:
provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

In another aspect, the method, further comprises:
i about 2-6 h after stopping the maintenance infusion, orally administering dofetilide every 12 h, the oral dose given being based on the creatinine clearance of the arrhythmic storm patients as given in the following table;

| Creatinine Clearance (CrCl) | | Oral Dose of Dofetilide |
|---|---|---|
| ≥60 | mL/min | 500 μg bid |
| 40-<60 | mL/min | 250 μg bid |
| 20-<40 | mL/min | 125 μg bid |
| <20 | mL/min | Dofetilide not indicated |

provided that if the patient's QTc increases by 15% over the baseline QTc or if the QTc is measured at >500 msec or >550 msec in patients with ventricular conduction abnormalities, the oral doses of dofetilide are reduced to 250 μg from 500 μg, 125 μg from 250 μg, or discontinued if originally 125 μg.

In some aspects, the QT_{c} is measured prior to administration of dofetilide to establish a baseline QT_{c} against which further QT_{c} measurements can be compared. In some aspects, during the initial infusion the QT_{c} is measured about every 15-30 minutes thereafter for 60 min and prior to the IV maintenance infusion and before each oral dose. These measurements can be discontinued once the physician observes that the patient is stable on dofetilide. For example, the QT_{c} measurements can be discontinued after the loading infusion of dofetilide is completed. Alternatively, the QT_{c} measurements can be discontinued after the first oral doses have been administered. The physician determines when to discontinue the QT_{c} measurements. Examples of a sufficient number of oral doses include 1, 2, 3, 4, 5, to 6 oral doses. After 6 oral doses steady state is typically obtained and no further change in maximal serum dofetilide concentration or QT prolongation is expected.

In another aspect, the patient has poor left ventricular function.

In another aspect. the patient is monitored via electrocardiography to determine the patient's QT_{c}.

The IV loading dose is typically about 450-500 μg of dofetilide. Examples include about 450, 455, 460, 465, 470, 475, 480, 485, 490, 495, to 500 μg of dofetilide. Typically, the loading dose chosen is an amount that achieves the predicted maximal serum concentration from orally administering 500 μg dofetilide.

The IV loading dose is typically given over about 30-60 minutes. Examples include about 30, 31, 32, 33, 34, 35, 36, 37, 38, 39, 40, 30, 41, 42, 43, 44, 45, 46, 47, 48, 49, 50, 30, 51, 52, 53, 54, 55, 56, 57, 58, 59, to 60 minutes.

In another aspect, the IV maintenance infusion—is started upon completion of the loading dose. In another aspect, the IV maintenance infusion is started about 0, 0.5, 1, 1.5, 2, 2.5, 3, 3.5, 4, 4.5, 5, 5.5, to 6 h after completion of the loading dose.

The IV maintenance infusion, which typically is given for about 12 h, can be discontinued at any time. In another aspect, the maintenance infusion is administered for about 1, 2, 3, 4, 5, 6, 7, 8, 9, 10, 11, 12, 13, 14, 15, 16, 17, 18, 19, 20, 21, 22, 23, to 24 h. Additional examples include about 1.5, 2, 2.5, 3, 3.5, to 4 days (or sometimes longer).

The IV maintenance infusion can be discontinued if needed (e.g., an excessively increased QT_{c} is measured). This is an advantage of an IV versus oral administration. The IV infusion can be quickly stopped if the patient is having an adverse effect to the dofetilide.

The IV maintenance infusion dose given is dependent upon the CrCl of the patient, as shown in the table below.

IV Maintenance Infusion of Dofetilide

| | | IV Maintenance Infusion |
|---|---|---|
| Creatinine Clearance (CrCl) | | (over 12 h) |
| ≥60 | mL/min | 450-500 μg |
| 40-<60 | mL/min | 225-250 μg |
| 20-<40 | mL/min | 100-125 μg |
| <20 | mL/min | Dofetilide not indicated |

For a patient with a CrCl of ≥60 mL/min, the IV maintenance infusion is typically about 450-500 μg of dofetilide and is typically given over about 12 h (but can vary as noted above). Examples include about 450, 455, 460, 465, 470, 475, 480, 485, 490, 495, to 500 μg of dofetilide. This equates to about 0.625-0.694 μg/min of dofetilide (450/720 to 500/720). In another aspect, the IV maintenance infusion is about 0.6, 0.61, 0.62, 0.63, 0.64, 0.65, 0.66, 0.67, 0.68, 0.69, to 0.7 μg/min.

For a patient with a CrCl of 40-<60 mL/min, the IV maintenance infusion is typically about 225-250 μg of dofetilide and is typically given over about 12 h (but can vary as noted above). Examples include about 225, 230, 235, 240, 245, to 250 μg of dofetilide. This equates to about 0.313-0.347 μg/min of dofetilide (225/720 to 250/720). In another aspect. the IV maintenance infusion is about 0.3, 0.31, 0.32, 0.33, 0.34, to 0.35 μg/min.

For a patient with a CrCl of 20-<40 mL/min, the IV maintenance infusion is typically about 100-125 μg of dofetilide and is typically given over about 12 h (but can vary as noted above). Examples include about 100, 105, 110, 115, 120, to 125 μg of dofetilide. This equates to about 0.139-0.174 μg/min of dofetilide (100/720 to 125/720). In another aspect. the IV maintenance infusion is about 0.13, 0.14, 0.15, 0.16, 0.17, to 0.18 μg/min.

A patient typically cannot take oral medication after the termination of the arrhythmic storm (following implantation of an implantable defibrillator). So, one advantage of the invention is that a patient having undergone the termination of the arrhythmic storm can be administered dofetilide before the patient would normally be capable of taking oral dofetilide. Once a patient is determined to have recovered enough from the termination of the arrhythmic storm (and the implantation of an implantable defibrillator) to take dofetilide orally, the dofetilide IV maintenance infusion can be discontinued and a switch-over to oral dofetilide accomplished. The patient's physician that determines when a patient can take dofetilide orally. Typically, a patient can take oral medication when they are awake with an intact gag reflex. In some aspects, this will be when the patient awakens after surgery. In other aspects, the patient may require more time after waking to be able to swallow a pill without aspiration.

In another aspect, the oral dose is started about 1, 2, 3, 4, 5, to 6 hours after the maintenance infusion has been stopped. In another aspect, the oral dose is started about 3-6 hours after the maintenance infusion has been stopped.

Oral dofetilide is available in capsule form in three sizes, 125, 250, and 500 μg. In another aspect, the patient is given dofetilide orally BID (once every 12 hours). Examples of these doses include 125, 250, 375 (e.g., 3×125 capsules or 125+250 capsules), and 500 μg.

The standard dose for patients having a creatinine clearance (CrCl)(or calculated GFR (glomerular filtration rate)) of ≥60 mL/min is 500 μg. However, per the table below, this dose is lowered if the patient's CRCL is <60 mL/min.

| Creatinine Clearance (CrCl) | | Starting Oral Dose of Dofetilide |
|---|---|---|
| ≥60 | mL/min | 500 μg bid |
| 40-<60 | mL/min | 250 μg bid |
| 20-<40 | mL/min | 125 μg bid |
| <20 | mL/min | Dofetilide not indicated |

The oral dose of dofetilide is also reduced if warranted by the patient's QT_{c}. For example, if the patient's QT_{c} increases by 15% over the baseline QT_{c} or if the QT_{c} is measured at >500 msec or >550 msec in patients with ventricular conduction abnormalities, the oral dose of dofetilide is reduced to 250 μg from 500 μg, or 125 μg from 250 μg, or discontinued if the original dose was 125 μg.

For a patient with a CrCl of >60 mL/min, the twice-daily oral doses of dofetilide are 500 μg. In this aspect, the oral doses are reduced to 250 μg if the patient's QT_{c} increased by 15% over baseline QT_{c} or if the QTc is measured at >500 msec or >550 msec if the patient has a ventricular conduction abnormality.

For a patient with a CrCl of 40-<60 mL/min, the twice-daily oral doses of dofetilide are 250 μg. In this aspect, the oral doses are reduced to 125 μg if the patient's QT_{c} increased by 15% over baseline QT_{c} or if the QT_{c} is measured at >500 msec or >550 msec if the patient has a ventricular conduction abnormality.

For a patient with a CrCl of 20-<40 mL/min, the twice-daily oral doses of dofetilide are 125 μg. In this aspect, the treatment is discontinued if the patient's QT_{c} is increased by 15% over baseline QT_{c} or if the QTc is measured at >500 msec or >550 msec if the patient has a ventricular conduction abnormality.

In an alternative aspect, a patient with a CrCl of 20-<40 mL/min is given 125 μg of dofetilide orally once daily. This once-daily regimen is selected based on the judgment of the patient's physician. In this aspect, the treatment is discontinued if the patient's QT_{c} is increased by 15% over baseline QT_{c} or if the QTc is measured at >500 msec or >550 msec if the patient has a ventricular conduction abnormality.

In another aspect, the patient has a CrCl of >60 mL/min, the IV maintenance infusion is about 450-500 μg of dofetilide and is given over about 12 h and the twice-daily oral doses of dofetilide are 500 μg. In this aspect, the oral doses are reduced to 250 μg if the patient's QT_{c} increased by 15% over baseline QT_{c} or if the QTc is measured at >500 msec or >550 msec if the patient has a ventricular conduction abnormality.

In another aspect, the patient has a CrCl of 40-<60 mL/min, the IV maintenance infusion is about 225-250 μg of dofetilide and is given over about 12 h and the twice-daily oral doses of dofetilide are 250 μg. In this aspect, the oral doses are reduced to 125 μg if the patient's QT_{c} increased by 15% over baseline QT_{c} or if the QTc is measured at >500 msec or >550 msec if the patient has a ventricular conduction abnormality.

In another aspect, the patient has a CrCl of 20-<40 mL/min, the IV maintenance infusion is about 100-125 μg of dofetilide and is given over about 12 h and the twice-daily oral doses of dofetilide are 125 μg. In this aspect, the treatment is discontinued if the patient's QT_{c} is increased by 15% over baseline QT_{c} or if the QTc is measured at >500 msec or >550 msec if the patient has a ventricular conduction abnormality.

In an alternative aspect, the patient has a CrCl of 20-<40 mL/min, the IV maintenance infusion is about 100-125 μg of dofetilide and is given over about 12 h, and the once-daily oral dose of dofetilide is 125 μg. In this aspect, the treatment is discontinued if the patient's QT_{c} is increased by 15% over baseline QT_{c} or if the QTc is measured at >500 msec or >550 msec if the patient has a ventricular conduction abnormality.

Suitable intravenous formulations are described in U.S. Pat. No. 11,364,213.

Examples of the concentration of a useful dofetilide intravenous solution includes about 1, 2, 3, 4, 5, 10, 15, 20, 25, 30, 35, 40, 45, 50, 55, 60, 65, 70, 75, 80, 85, 90, 95 to 100 μg/mL.

The invention may be embodied in other specific forms without departing from the spirit or essential attributes thereof. This invention encompasses all combinations of aspects of the invention noted herein. It is understood that any and all embodiments of the invention may be taken in conjunction with any other embodiment or embodiments to describe additional embodiments. It is also to be understood that each individual element of the embodiments is intended to be taken individually as its own independent embodiment. Furthermore, any element of an embodiment is meant to be combined with any and all other elements from any embodiment to describe an additional embodiment.

Other features of the invention will become apparent in the course of the following descriptions of exemplary embodiments that are given for illustration of the invention and are not intended to be limiting thereof.

### EXAMPLES

### Example 3

A 70 kg patient with a CrCl>60 mL/min presents with arrhythmic storm after implementation of an implantable defibrillator. The patient's physician determines to terminate the arrhythmic storm with an infusion of dofetilide. The patient has an ECG continuously monitored. The patient is then subjected to the following treatment with dofetilide.
(D) Hour 0: Intravenous (IV) Loading Dose: 450 μg, infusion over 1 h measuring QT_{c}, HR, and BP every 15 minutes;
(E) Hour 1: IV Maintenance Infusion: 450 μg, 12 h infusion, started at the end of the loading dose infusion; and,
(F) Hour 16: Oral Dose: 500 μg given orally every 12 hours (BID), started 3 h after termination of IV maintenance infusion.

FIG. 1 shows the estimated blood dofetilide concentration obtained with the above described dosage regimen. This graph was obtained by modeling the above dosage regimen. The software packages NONMEM™ version 7.4 (ICON, Hanover, MD, USA) and MWpharm (Mediware, Prague, CZ) 6 were used for the Bayesian PK modeling. PsN7 (Dept. of Pharmacy, Uppsala University, Uppsala, Sweden) was used for automation procedures. R (version 3.5.1, The R Foundation for Statistical Computing) was used for data preparation, graphical analysis, linear regression analysis, and statistical summaries. R package ‘mrgsolve’ was used for simulations.

Step (A): the loading dose, which in this example is a 450 μg IV infusion of dofetilide over 1 h, is expected to achieve the predicted maximal serum concentration that one would expect from 500 μg-dofetilide chronically dosed orally. This would reach peak, if administered orally, after 6 doses twice daily of dofetilide. The peak concentration will typically be reached at termination of infusion.

QT_{c} would be measured every 15 mins during the infusion.

Step (B): the IV maintenance infusion of 450 μg of dofetilide over 12 h (0.625 μg/min) is initiated at the end of the 1 h loading IV. This dose can be maintained until the patient is awake and able to take dofetilide orally.

Once the patient can take dofetilide orally, the dofetilide maintenance IV is stopped. Starting about 3 h after stopping the IV maintenance infusion, an oral dose of 500 μg of dofetilide is administered every 12 h (BID) thereafter.

If the QT_{c} has increased by 15% over baseline QT_{c} or if a QT_{c}>500 msec is observed (550 msec in patients with ventricular conduction abnormalities), subsequent oral doses would be reduced to 250 μg BID (or lower if the original oral dose called for is lower, see below).

It is noted that if patients present with a lower than normal CrCl, the initial target concentration would be the same, but the oral (maintenance) dose administered would be lower; 250 μg or 125 μg BID (based on the chart below).

| Creatinine Clearance (CrCl) | | Oral Dose of Dofetilide |
|---|---|---|
| ≥60 | mL/min | 500 μg bid |
| 40-<60 | mL/min | 250 μg bid |
| 20-<40 | mL/min | 125 μg bid |
| <20 | mL/min | Dofetilide not indicated |

Further, in patients that show excessive QT_{c} prolongation at initial loading (>500 msec or >550 msec in patients with ventricular conduction abnormalities), the first oral dose would be reduced to 250 μg (or 125 μg if starting oral dose was 250 μg based on the above chart) and the peak concentration expected in 4 h with QT_{c} re-evaluated. In this way, a concentration projection from a dofetilide chronic oral dosing of 250 μg could be readily evaluated, with QT_{c} observation.

### Example 4

A 75 kg patient with a CrCl of 45 mL/min presents with arrhythmic storm after implementation of an implantable defibrillator. The patient's physician determines to terminate the arrhythmic storm with an infusion of dofetilide. The patient's ECG is continuously monitored. The patient is then subjected to the following treatment with dofetilide.
(A) Hour 0: IV Loading Dose: 450 μg, infusion over 1 h measuring QT_{c}, HR, and BP every 15 minutes.
(B) Hour 4: Maintenance Infusion: 225 μg infused over 12 hours started 3 hours after the end of the IV Loading Dose.
(C) Hour 21: Oral Dose initiated 250 μg given orally every 12 hours, started 5 hours after termination of IV maintenance infusion.

Numerous modifications and variations of the invention are possible in light of the above teachings. It is therefore to be understood that within the scope of the appended embodiments, the invention may be practiced otherwise than as specifically described herein.

### EMBODIMENTS—B. TERMINATION OF ARRHYTHMIC STORM

Embodiment 1: A method of terminating arrhythmic storm in a patient after implementation of an implantable defibrillator, comprising:
a intravenously administering a loading dose of dofetilide to the patient who presents with arrhythmic storm after implementation of an implantable defibrillator, wherein:
   (A) the loading dose is about 450-500 μg of dofetilide; and,
   (B) the loading dose is administered over about 30-60 minutes;
b about 0-4 h after completion of the IV loading dose, intravenously administering a maintenance infusion of dofetilide over about 12 h, the maintenance infusion given being based on the creatinine clearance (CrCl) of the patient as given in the following table;

| | | IV Maintenance Infusion | Oral Dose |
|---|---|---|---|
| CrCl | | (over 12 h) | (every 12 h) |
| ≥60 | mL/min | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

c once the patient has recovered from the termination of the arrhythmic storm to take dofetilide orally, stopping the IV maintenance infusion; and,
d about 2-6 h after stopping the IV maintenance infusion, orally administering dofetilide every 12 h, the oral dose given being based on the CrCl of the patient as given in the above table;
provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

Embodiment 2: The method of Embodiment 1, further comprising: measuring the QT_{c} of the patient prior to the IV loading dose of dofetilide to establish a baseline QT_{c} and then measuring the QT_{c} about every 15-30 minutes thereafter for 60 min and prior to the IV maintenance infusion and before each oral dose.

Embodiment 3: The method of Embodiment 1, wherein the loading dose is about 450 μg.

Embodiment 4: The method of Embodiment 1, wherein the loading dose is about 460 μg.

Embodiment 5: The method of Embodiment 1, wherein the loading dose is about 470 μg.

Embodiment 6: The method of Embodiment 1, wherein the loading dose is about 480 μg.

Embodiment 7: The method of Embodiment 1, wherein the loading dose is about 490 μg.

Embodiment 8: The method of Embodiment 1, wherein the loading dose is about 500 μg.

Embodiment 9: The method of Embodiment 1, wherein the loading dose is administered over about 30 minutes.

Embodiment 10: The method of Embodiment 1, wherein the loading dose is administered over about 40 minutes.

Embodiment 11: The method of Embodiment 1, wherein the loading dose is administered over about 50 minutes.

Embodiment 12: The method of Embodiment 1, wherein the loading dose is administered over about 60 minutes.

Embodiment 13: The method of Embodiment 1, wherein the maintenance infusion is started about 0 h after completion of the loading dose.

Embodiment 14: The method of Embodiment 1, wherein the maintenance infusion is started about 1 h after completion of the loading dose.

Embodiment 15: The method of Embodiment 1, wherein the maintenance infusion is started about 2 h after completion of the loading dose.

Embodiment 16: The method of Embodiment 1, wherein the maintenance infusion is started about 3 h after completion of the loading dose.

Embodiment 17: The method of Embodiment 1, wherein the maintenance infusion is started about 4 h after completion of the loading dose.

Embodiment 18: The method of Embodiment 1, wherein the patient has a CrCl of >60 mL/min, the IV maintenance infusion is about 450-500 μg given over about 12 h and the oral doses are 500 μg.

Embodiment 19: The method of Embodiment 18, wherein the oral doses are reduced to 250 μg due to a QT_{c} that increased by 15% over baseline QT_{c} or if the QT_{c} is measured at >500 msec or >550 msec if the patient has a ventricular conduction abnormality.

Embodiment 20 The method of Embodiment 1, wherein the patient has a CrCl of 40-<60 mL/min, the IV maintenance infusion is about 225-250 μg given over about 12 h and the oral doses are 250 μg.

Embodiment 21: The method of Embodiment 20, wherein the oral doses are reduced to 125 μg due to a QT_{c} that increased by 15% over baseline QT_{c} or if the QT_{c} is measured at >500 msec or >550 msec if the patient has a ventricular conduction abnormality.

Embodiment 22: The method of Embodiment 1, wherein the patient has a CrCl of 20-<40 mL/min, the IV maintenance infusion is about 100-125 μg given over about 12 h and the oral doses are 125 μg.

Embodiment 23: The method of Embodiment 22, wherein the oral doses are discontinued due to a QT_{c} that increased by 15% over baseline QT_{c} or if the QT_{c} is measured at >500 msec is observed or >550 msec if the patient has a ventricular conduction abnormality.

### FURTHER EMBODIMENTS—B. TERMINATION OF ARRHYTHMIC STORM

Embodiment 1: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 450-500 μg dofetilide to those patients having a creatine clearance of 60 mL/min or higher;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 2: The method of embodiment 1, which is a method of terminating arrhythmic storm in patients following implantation of a cardiac defibrillator.

Embodiment 3: The method of embodiment 1, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable. [

Embodiment 4: The method of embodiment 3, wherein the patient's physician determines when the patient is stable.

Embodiment 5: The method of embodiment 4, wherein the patient may be stable after the loading infusion of dofetilide is complete, or after the first oral doses have been administered.

Embodiment 6: The method of embodiment 1, wherein the loading dose is 450-500 μg dofetilide.

Embodiment 7: The method of embodiment 1, wherein 1-3 hours after completion of the loading dose, a maintenance dose (“the IV maintenance dose”) of 450-500 μg dofetilide is administered to those patients having a creatine clearance of 60 mL/min or higher.

Embodiment 8: The method of embodiment 1, wherein the IV maintenance dose of about 450-500 μg dofetilide.

Embodiment 9: The method of embodiment 1, wherein the creatine clearance is 60 mL/min or higher.

Embodiment 10: The method of embodiment 1, 1. wherein 3-5 hours after discontinuing the IV maintenance dose, 500 μg dofetilide is orally administered every 12 hours to those patients having a creatine clearance of 60 mL/min or higher.

Embodiment 11: The method of embodiment 1, further comprising measuring the patient's creatine clearance as an approximation of the glomerular filtration rate (GFR), prior to administering the IV maintenance dose, to determine the amount of dofetilide indicated for the IV maintenance dose.

Embodiment 12: The method of embodiment 1, further comprising measuring the patient's creatine clearance as an approximation of the glomerular filtration rate (GFR), prior to orally administering dofetilide, to determine the amount of dofetilide indicated for the oral dose.

Embodiment 13: The method of embodiment 1, wherein the patient has sufficiently recovered from the termination of the arrhythmic storm and is orally administered dofetilide when awake after surgery with an intact gag reflex.

Embodiment 14: The method of embodiment 1, wherein the intravenous loading dose is administered over about 30-60 minutes.

Embodiment 15: The method of embodiment 1, wherein the IV maintenance dose is administered over about 12 hours.

Embodiment 16: The method of embodiment 1, wherein the dofetilide is fully loaded in less than three days.

Embodiment 17: The method of embodiment 16, wherein the dofetilide is fully loaded when it reaches steady state concentration in the blood.

Embodiment 18: The method of embodiment 1, wherein the intravenous dofetilide is administered in a first loading dose and an ongoing IV maintenance dose.

Embodiment 19: The method of embodiment 1, wherein intravenous dofetilide administration prevents possible arrythmias by avoiding excessive dofetilide blood levels.

Embodiment 20: The method of embodiment 1, wherein the patient can be loaded with dofetilide by intravenous administration before the patient would be awake after surgery with an intact gag reflex and capable of taking oral dofetilide.

Embodiment 21: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 450-500 μg dofetilide to those patients having a creatine clearance of 60 mL/min or higher;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 22: The method of embodiment 21, which is a method of terminating arrhythmic storm in patients following implantation of a cardiac defibrillator.

Embodiment 23: The method of embodiment 21, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable.

Embodiment 24: The method of embodiment 23, wherein the patient's physician determines when the patient is stable.

Embodiment 25: The method of embodiment 24, wherein the patient may be stable after the loading infusion of dofetilide is complete, or after the first oral doses have been administered.

Embodiment 26: The method of embodiment 21, wherein the loading dose is 450-500 μg dofetilide.

Embodiment 27: The method of embodiment 21, wherein 1-3 hours after completion of the loading dose, a maintenance dose (“the IV maintenance dose”) of 450-500 μg dofetilide is administered to those patients having a creatine clearance of 60 mL/min or higher.

Embodiment 28: The method of embodiment 21, wherein the IV maintenance dose of about 450-500 μg dofetilide.

Embodiment 29: The method of embodiment 21, wherein the creatine clearance is 60 mL/min or higher.

Embodiment 30: The method of embodiment 21, 1. wherein the IV maintenance dose is stopped after 3-5 hours. the IV maintenance dose.

Embodiment 31: The method of embodiment 21, further comprising measuring the patient's creatine clearance as an approximation of the glomerular filtration rate (GFR), prior to administering the IV maintenance dose, to determine the amount of dofetilide indicated for the IV maintenance dose.

Embodiment 32: The method of embodiment 21, further comprising measuring the patient's creatine clearance as an approximation of the glomerular filtration rate (GFR), prior to orally administering dofetilide, to determine the amount of dofetilide indicated for the oral dose.

Embodiment 33: The method of embodiment 21, wherein the patient has sufficiently recovered from the termination of the arrhythmic storm and is orally administered dofetilide when awake after surgery with an intact gag reflex.

Embodiment 34: The method of embodiment 21, wherein the intravenous loading dose is administered over about 30-60 minutes.

Embodiment 35: The method of embodiment 21, wherein the IV maintenance dose is administered over about 12 hours.

Embodiment 36: The method of embodiment 21, wherein the dofetilide is fully loaded in less than three days.

Embodiment 37: The method of embodiment 36, wherein the dofetilide is fully loaded when it reaches steady state concentration in the blood.

Embodiment 38: The method of embodiment 21, wherein the intravenous dofetilide is administered in a first loading dose and an ongoing IV maintenance dose.

Embodiment 39: The method of embodiment 21, wherein intravenous dofetilide administration prevents possible arrythmias by avoiding excessive dofetilide blood levels.

Embodiment 40: The method of embodiment 21, wherein the patient can be loaded with dofetilide by intravenous administration before the patient would be awake after surgery with an intact gag reflex and capable of taking oral dofetilide.

Embodiment 41: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 450-500 μg dofetilide to those patients having a creatine clearance of 60 mL/min or higher;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 125 μg dofetilide every 12 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 42: The method of embodiment 41, which is a method of terminating arrhythmic storm in patients following implantation of a cardiac defibrillator.

Embodiment 43: The method of embodiment 41, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable.

Embodiment 44: The method of embodiment 43, wherein the patient's physician determines when the patient is stable.

Embodiment 45: The method of embodiment 44, wherein the patient may be stable after the loading infusion of dofetilide is complete, or after the first oral doses have been administered.

Embodiment 46: The method of embodiment 41, wherein the loading dose is 450-500 μg dofetilide.

Embodiment 47: The method of embodiment 41, wherein 1-3 hours after completion of the loading dose, a maintenance dose (“the IV maintenance dose”) of 450-500 μg dofetilide is administered to those patients having a creatine clearance of 60 mL/min or higher.

Embodiment 48: The method of embodiment 41, wherein the IV maintenance dose is 450-500 μg dofetilide.

Embodiment 49: The method of embodiment 41, wherein the creatine clearance is 60 mL/min or higher.

Embodiment 50: The method of embodiment 41, 1. wherein 3-5 hours after discontinuing the IV maintenance dose, 125 μg dofetilide is orally administered every 12 hours to those patients having a creatine clearance of 20-<40 mL/min.

Embodiment 51: The method of embodiment 41, further comprising measuring the patient's creatine clearance as an approximation of the glomerular filtration rate (GFR), prior to administering the IV maintenance dose, to determine the amount of dofetilide indicated for the IV maintenance dose.

Embodiment 52: The method of embodiment 41, further comprising measuring the patient's creatine clearance as an approximation of the glomerular filtration rate (GFR), prior to orally administering dofetilide, to determine the amount of dofetilide indicated for the oral dose.

Embodiment 53: The method of embodiment 41, wherein the patient has sufficiently recovered from the termination of the arrhythmic storm and is orally administered dofetilide when awake after surgery with an intact gag reflex.

Embodiment 54: The method of embodiment 41, wherein the intravenous loading dose is administered over about 30-60 minutes.

Embodiment 55: The method of embodiment 41, wherein the IV maintenance dose is administered over about 12 hours.

Embodiment 56: The method of embodiment 41, wherein the dofetilide is fully loaded in less than three days.

Embodiment 57: The method of embodiment 56, wherein the dofetilide is fully loaded when it reaches steady state concentration in the blood.

Embodiment 58: The method of embodiment 41, wherein the intravenous dofetilide is administered in a first loading dose and an ongoing IV maintenance dose.

Embodiment 59: The method of embodiment 41, wherein intravenous dofetilide administration prevents possible arrythmias by avoiding excessive dofetilide blood levels.

Embodiment 60: The method of embodiment 41, wherein the patient can be loaded with dofetilide by intravenous administration before the patient would be awake after surgery with an intact gag reflex and capable of taking oral dofetilide.

Embodiment 61: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 225-250 μg dofetilide to those patients having a creatine clearance of 40-<60 mL/min;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 62: The method of embodiment 61, which is a method of terminating arrhythmic storm in patients following implantation of a cardiac defibrillator.

Embodiment 63: The method of embodiment 61, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable.

Embodiment 64: The method of embodiment 63, wherein the patient's physician determines when the patient is stable.

Embodiment 65: The method of embodiment 64, wherein the patient may be stable after the loading infusion of dofetilide is complete, or after the first oral doses have been administered.

Embodiment 66: The method of embodiment 61, wherein the loading dose is 450-500 μg dofetilide.

Embodiment 67: The method of embodiment 61, wherein 1-3 hours after completion of the loading dose, a maintenance dose (“the IV maintenance dose”) of 450-500 μg dofetilide is administered to those patients having a creatine clearance of 60 mL/min or higher.

Embodiment 68: The method of embodiment 61, wherein the IV maintenance dose is 225-250 μg dofetilide.

Embodiment 69: The method of embodiment 61, wherein the creatine clearance is 60 mL/min or higher.

Embodiment 70: The method of embodiment 61, wherein 3-5 hours after discontinuing the IV maintenance dose, 500 μg dofetilide is orally administered every 12 hours to those patients having a creatine clearance of 60 mL/min or higher.

Embodiment 71: The method of embodiment 61, further comprising measuring the patient's creatine clearance as an approximation of the glomerular filtration rate (GFR), prior to administering the IV maintenance dose, to determine the amount of dofetilide indicated for the IV maintenance dose.

Embodiment 72: The method of embodiment 61, further comprising measuring the patient's creatine clearance as an approximation of the glomerular filtration rate (GFR), prior to orally administering dofetilide, to determine the amount of dofetilide indicated for the oral dose.

Embodiment 73: The method of embodiment 61, wherein the patient has sufficiently recovered from the termination of the arrhythmic storm and is orally administered dofetilide when awake after surgery with an intact gag reflex.

Embodiment 74: The method of embodiment 61, wherein the intravenous loading dose is administered over about 30-60 minutes.

Embodiment 75: The method of embodiment 61, wherein the IV maintenance dose is administered over about 12 hours.

Embodiment 76: The method of embodiment 61, wherein the dofetilide is fully loaded in less than three days.

Embodiment 77: The method of embodiment 76, wherein the dofetilide is fully loaded when it reaches steady state concentration in the blood.

Embodiment 78: The method of embodiment 61, wherein the intravenous dofetilide is administered in a first loading dose and an ongoing IV maintenance dose.

Embodiment 79: The method of embodiment 61, wherein intravenous dofetilide administration prevents possible arrythmias by avoiding excessive dofetilide blood levels.

Embodiment 80: The method of embodiment 61, wherein the patient can be loaded with dofetilide by intravenous administration before the patient would be awake after surgery with an intact gag reflex and capable of taking oral dofetilide.

Embodiment 81: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 225-250 μg dofetilide to those patients having a creatine clearance of 40-<60 mL/min;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 250 μg dofetilide every 12 hours to those patients having a creatine clearance of 40-<60 mL/min.
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 82: The method of embodiment 81, which is a method of terminating arrhythmic storm in patients following implantation of a cardiac defibrillator.

Embodiment 83: The method of embodiment 81, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable.

Embodiment 84: The method of embodiment 83, wherein the patient's physician determines when the patient is stable.

Embodiment 85: The method of embodiment 84, wherein the patient may be stable after the loading infusion of dofetilide is complete. or after the first oral doses have been administered.

Embodiment 86: The method of embodiment 81, wherein the loading dose is 450-500 μg dofetilide.

Embodiment 87: The method of embodiment 81, wherein 1-3 hours after completion of the loading dose, a maintenance dose (“the IV maintenance dose”) of 450-500 μg dofetilide is administered to those patients having a creatine clearance of 60 mL/min or higher.

Embodiment 88: The method of embodiment 81, wherein the IV maintenance dose is 225-250 μg dofetilide.

Embodiment 89: The method of embodiment 81, wherein 2-5 hours after discontinuing the IV maintenance dose, 250 μg dofetilide is orally administered every 12 hours to those patients having a creatine clearance of 40-<60 mL/min.

Embodiment 90: The method of embodiment 81, further comprising measuring the patient's creatine clearance as an approximation of the glomerular filtration rate (GFR), prior to administering the IV maintenance dose, to determine the amount of dofetilide indicated for the IV maintenance dose.

Embodiment 91: The method of embodiment 81, further comprising measuring the patient's creatine clearance as an approximation of the glomerular filtration rate (GFR), prior to orally administering dofetilide, to determine the amount of dofetilide indicated for the oral dose.

Embodiment 92: The method of embodiment 81, wherein the patient has sufficiently recovered from the termination of the arrhythmic storm and is orally administered dofetilide when awake after surgery with an intact gag reflex.

Embodiment 93: The method of embodiment 81, wherein the intravenous loading dose is administered over about 30-60 minutes.

Embodiment 94: The method of embodiment 81, wherein the IV maintenance dose is administered over about 12 hours.

Embodiment 95: The method of embodiment 81, wherein the dofetilide is fully loaded in less than three days.

Embodiment 96: The method of embodiment 95, wherein the dofetilide is fully loaded when it reaches steady state concentration in the blood.

Embodiment 97: The method of embodiment 81, wherein the intravenous dofetilide is administered in a first loading dose and an ongoing IV maintenance dose.

Embodiment 98: The method of embodiment 81, wherein intravenous dofetilide administration prevents possible arrythmias by avoiding excessive dofetilide blood levels.

Embodiment 99: The method of embodiment 81, wherein the patient can be loaded with dofetilide by intravenous administration before the patient would be awake after surgery with an intact gag reflex and capable of taking oral dofetilide.

Embodiment 100: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 225-250 μg dofetilide to those patients having a creatine clearance of 40-<60 mL/min;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 125 μg dofetilide every 12 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and wherein the patient is monitored to ensure no excessive QT prolongation results in cardiac repolarization abnormalities which cause life threatening ventricular arrhythmias.

Embodiment 101: The method of embodiment 100, which is a method of terminating arrhythmic storm in patients following implantation of a cardiac defibrillator.

Embodiment 102: The method of embodiment 100, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable.

Embodiment 103: The method of embodiment 102, wherein the patient's physician determines when the patient is stable.

Embodiment 104: The method of embodiment 103, wherein the patient may be stable after the loading infusion of dofetilide is complete. or after the first oral doses have been administered.

Embodiment 105: The method of embodiment 100, wherein the loading dose is 450-500 μg dofetilide.

Embodiment 106: The method of embodiment 100, wherein 1-3 hours after completion of the loading dose, a maintenance dose (“the IV maintenance dose”) of 450-500 μg dofetilide is administered to those patients having a creatine clearance of 60 mL/min or higher.

Embodiment 107: The method of embodiment 100, wherein the IV maintenance dose is 225-250 μg dofetilide.

Embodiment 108: The method of embodiment 100, wherein 2-5 hours after discontinuing the IV maintenance dose, 125 μg dofetilide is orally administered every 12 hours to those patients having a creatine clearance of 20-<40 mL/min.

Embodiment 109: The method of embodiment 100, further comprising measuring the patient's creatine clearance as an approximation of the glomerular filtration rate (GFR), prior to administering the IV maintenance dose, to determine the amount of dofetilide indicated for the IV maintenance dose.

Embodiment 110: The method of embodiment 100, further comprising measuring the patient's creatine clearance as an approximation of the glomerular filtration rate (GFR), prior to orally administering dofetilide, to determine the amount of dofetilide indicated for the oral dose.

Embodiment 111: The method of embodiment 100, wherein the patient has sufficiently recovered from the termination of the arrhythmic storm and is orally administered dofetilide when awake after surgery with an intact gag reflex.

Embodiment 112: The method of embodiment 100, wherein the intravenous loading dose is administered over about 30-60 minutes.

Embodiment 113: The method of embodiment 100, wherein the IV maintenance dose is administered over about 12 hours.

Embodiment 114: The method of embodiment 100, wherein the dofetilide is fully loaded in less than three days.

Embodiment 115: The method of embodiment 114, wherein the dofetilide is fully loaded when it reaches steady state concentration in the blood.

Embodiment 116: The method of embodiment 100, wherein the intravenous dofetilide is administered in a first loading dose and an ongoing IV maintenance dose.

Embodiment 117: The method of embodiment 100, wherein intravenous dofetilide administration prevents possible arrythmias by avoiding excessive dofetilide blood levels.

Embodiment 118: The method of embodiment 100, wherein the patient can be loaded with dofetilide by intravenous administration before the patient would be awake after surgery with an intact gag reflex and capable of taking oral dofetilide.

Embodiment 119: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 100-125 μg dofetilide to those patients having a creatine clearance of 20-<40 mL/min;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and wherein the loading dose is expected to achieve maximum serum concentration at the termination of the infusion; and wherein the patient is monitored to ensure no excessive QT prolongation results in cardiac repolarization abnormalities which cause life threatening ventricular arrhythmias.

Embodiment 120: The method of embodiment 119, which is a method of terminating arrhythmic storm in patients following implantation of a cardiac defibrillator.

Embodiment 121: The method of embodiment 119, further comprising measuring the patient's QTc prior to intravenously administering the loading dose of dofetilide to establish baseline QTc, thereafter measuring the QTc every 15-30 minutes during infusion of the loading dose, thereafter about every 60 minutes, until the patient is stable.

Embodiment 122: The method of embodiment 121, wherein the patient's physician determines when the patient is stable.

Embodiment 123: The method of embodiment 122, wherein the patient may be stable after the loading infusion of dofetilide is complete, or after the first oral doses have been administered.

Embodiment 124: The method of embodiment 119, wherein the loading dose is 450-500 μg dofetilide.

Embodiment 125: The method of embodiment 119, wherein 1-3 hours after completion of the loading dose, a maintenance dose (“the IV maintenance dose”) of 450-500 μg dofetilide is administered to those patients having a creatine clearance of 60 mL/min or higher.

Embodiment 126: The method of embodiment 119, wherein the loading dose is 450-500 μg dofetilide.

Embodiment 127: The method of embodiment 119, wherein the creatine clearance is 60 mL/min or higher.

Embodiment 128: The method of embodiment 119, wherein 3-5 hours after discontinuing the IV maintenance 500 μg dofetilide is orally administering every 12 hours to those patients having a creatine clearance of 60 mL/min or higher.

Embodiment 129: The method of embodiment 119, further comprising measuring the patient's creatine clearance as an approximation of the glomerular filtration rate (GFR), prior to administering the IV maintenance dose, to determine the amount of dofetilide indicated for the IV maintenance dose.

Embodiment 130: The method of embodiment 119, further comprising measuring the patient's creatine clearance as an approximation of the glomerular filtration rate (GFR), prior to orally administering dofetilide, to determine the amount of dofetilide indicated for the oral dose.

Embodiment 131: The method of embodiment 119, wherein the patient has sufficiently recovered from the termination of the arrhythmic storm and is orally administered dofetilide when awake after surgery with an intact gag reflex.

Embodiment 132: The method of embodiment 119, wherein the intravenous loading dose is administered over about 30-60 minutes.

Embodiment 133: The method of embodiment 119, wherein the IV maintenance dose is administered over about 12 hours.

Embodiment 134: The method of embodiment 119, wherein the dofetilide is fully loaded in less than three days.

Embodiment 135: The method of embodiment 134, wherein the dofetilide is fully loaded when it reaches steady state concentration in the blood.

Embodiment 136: The method of embodiment 119, wherein the intravenous dofetilide is administered in a first loading dose and an ongoing IV maintenance dose.

Embodiment 137: The method of embodiment 119, wherein intravenous dofetilide administration prevents possible arrythmias by avoiding excessive dofetilide blood levels.

Embodiment 138: The method of embodiment 119, wherein the patient can be loaded with dofetilide by intravenous administration before the patient would be awake after surgery with an intact gag reflex and capable of taking oral dofetilide.

Embodiment 139: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 100-125 μg dofetilide to those patients having a creatine clearance of 20-<40 mL/min;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and wherein the patient is monitored to ensure no excessive QT prolongation results in cardiac repolarization abnormalities which cause life threatening ventricular arrhythmias.

Embodiment 140: The method of embodiment 139, which is a method of terminating arrhythmic storm in patients following implantation of a cardiac defibrillator.

Embodiment 141: The method of embodiment 139, further comprising measuring the patient's QTc prior to intravenously administering the loading dose of dofetilide to establish baseline QTc. thereafter measuring the QTc every 15-30 minutes during infusion of the loading dose, thereafter about every 60 minutes, until the patient is stable.

Embodiment 142: The method of embodiment 141, wherein the patient's physician determines when the patient is stable.

Embodiment 143: The method of embodiment 142, wherein the patient may be stable after the loading infusion of dofetilide is complete, or after the first oral doses have been administered.

Embodiment 144: The method of embodiment 139, wherein the loading dose is 450-500 μg dofetilide.

Embodiment 145: The method of embodiment 139, wherein the 1-3 hours after completion of the loading dose, a maintenance dose (“the IV maintenance dose”) of 450-500 μg dofetilide is administered to those patients having a creatine clearance of 60 mL/min or higher.

Embodiment 146: The method of embodiment 139, wherein the loading dose is 450-500 μg dofetilide.

Embodiment 147: The method of embodiment 139, wherein 2-5 hours after discontinuing the IV maintenance dose, 250 μg dofetilide is orally administered every 12 hours to those patients having a creatine clearance of 40-<60 mL/min.

Embodiment 148: The method of embodiment 139, further comprising measuring the patient's creatine clearance as an approximation of the glomerular filtration rate (GFR), prior to administering the IV maintenance dose, to determine the amount of dofetilide indicated for the IV maintenance dose.

Embodiment 149: The method of embodiment 139, further comprising measuring the patient's creatine clearance as an approximation of the glomerular filtration rate (GFR), prior to orally administering dofetilide, to determine the amount of dofetilide indicated for the oral dose.

Embodiment 150: The method of embodiment 139, wherein the patient has sufficiently recovered from the termination of the arrhythmic storm and is orally administered dofetilide when awake after surgery with an intact gag reflex.

Embodiment 151: The method of embodiment 139, wherein the intravenous loading dose is administered over about 30-60 minutes.

Embodiment 152: The method of embodiment 139, wherein the IV maintenance dose is administered over about 12 hours.

Embodiment 153: The method of embodiment 139, wherein the dofetilide is fully loaded in less than three days.

Embodiment 154: The method of embodiment 153, wherein the dofetilide is fully loaded when it reaches steady state concentration in the blood.

Embodiment 155: The method of embodiment 139, wherein the intravenous dofetilide is administered in a first loading dose and an ongoing IV maintenance dose.

Embodiment 156: The method of embodiment 139, wherein intravenous dofetilide administration prevents possible arrythmias by avoiding excessive dofetilide blood levels.

Embodiment 157: The method of embodiment 139, wherein the patient can be loaded with dofetilide by intravenous administration before the patient would be awake after surgery with an intact gag reflex and capable of taking oral dofetilide.

Embodiment 158: A method of terminating arrhythmic storm in patients in order to rapidly terminate the arrhythmic storm and prevent its recurrence, comprising:
a. intravenously administering to a patient in need thereof a loading dose of about 450-500 μg dofetilide over about 30-60 minutes;
b. about 0-4 hours after completion of the loading dose, intravenously administering a maintenance dose (“the IV maintenance dose”) of about 100-125 μg dofetilide to those patients having a creatine clearance of 20-<40 mL/min;
c. administering the IV maintenance dose over about 12 hours;
d. discontinuing the IV maintenance dose for those patients who have sufficiently recovered from termination of the arrhythmic storm; and
e. about 2-6 hours after discontinuing the IV maintenance dose, orally administering 125 μg dofetilide every 12 hours or every 24 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 159: The method of embodiment 158, which is a method of terminating arrhythmic storm in patients following implantation of a cardiac defibrillator.

Embodiment 160: The method of embodiment 158, further comprising measuring the patient's QTc prior to intravenously administering the loading dose of dofetilide to establish baseline QTc, thereafter measuring the QTc every 15-30 minutes during infusion of the loading dose, thereafter about every 60 minutes. until the patient is stable.

Embodiment 161: The method of embodiment 160, wherein the patient's physician determines when the patient is stable.

Embodiment 162: The method of embodiment 161, wherein the patient may be stable after the loading infusion of dofetilide is complete, or after the first oral doses have been administered.

Embodiment 163: The method of embodiment 158, wherein the loading dose is 450-500 μg dofetilide.

Embodiment 164: The method of embodiment 158, wherein 1-3 hours after completion of the loading dose, a maintenance dose (“the IV maintenance dose”) of 450-500 μg dofetilide is administered to those patients having a creatine clearance of 60 mL/min or higher.

Embodiment 165: The method of embodiment 158, wherein the loading dose is 450-500 μg dofetilide.

Embodiment 166: The method of embodiment 158, wherein the IV maintenance dose is stopped after 3-5 hours.

Embodiment 167: The method of embodiment 158, further comprising measuring the patient's creatine clearance as an approximation of the glomerular filtration rate (GFR), prior to administering the IV maintenance dose, to determine the amount of dofetilide indicated for the IV maintenance dose.

Embodiment 168: The method of embodiment 158, further comprising measuring the patient's creatine clearance as an approximation of the glomerular filtration rate (GFR), prior to orally administering dofetilide, to determine the amount of dofetilide indicated for the oral dose.

Embodiment 169: The method of embodiment 158, wherein the patient has sufficiently recovered from the termination of the arrhythmic storm and is orally administered dofetilide when awake after surgery with an intact gag reflex.

Embodiment 170: The method of embodiment 158, wherein the intravenous loading dose is administered over about 30-60 minutes.

Embodiment 171: The method of embodiment 158, wherein the IV maintenance dose is administered over about 12 hours.

Embodiment 172: The method of embodiment 158, wherein the dofetilide is fully loaded in less than three days.

Embodiment 173: The method of embodiment 172, wherein the dofetilide is fully loaded when it reaches steady state concentration in the blood.

Embodiment 174: The method of embodiment 158, wherein the intravenous dofetilide is administered in a first loading dose and an ongoing IV maintenance dose.

Embodiment 175: The method of embodiment 158, wherein intravenous dofetilide administration prevents possible arrythmias by avoiding excessive dofetilide blood levels.

Embodiment 176: The method of embodiment 158, wherein the patient can be loaded with dofetilide by intravenous administration before the patient would be awake after surgery with an intact gag reflex and capable of taking oral dofetilide.

### INTRAVENOUS DOFETILIDE TO CONVERT ATRIAL FIBRILLATION/FLUTTER

All references cited herein are hereby incorporated in their entirety herein by reference.

### Definitions

AF is atrial fibrillation.

AFL is atrial flutter, which is very similar to AF. Typically, the symptoms of a patient with AFL are more organized (e.g., the heart rate is less chaotic).

About is defined as +/−10% of the numerical value.

BID or bid or b.i.d. refers to twice-daily or once every 12 hours.

BP is blood pressure.

HR is heart rate.

IV means intravenous or intravenously.

Highly symptomatic AF/AFL refers to the level of symptoms shown by a patient. AF/AFL can be asymptomatic, symptomatic, or highly symptomatic. Symptomatic can include patients with palpitations, dizziness, reduced exercise capacity, and pre-syncope. Highly symptomatic refers to patients with symptoms reflecting more severe hemodynamic compromise. Highly symptomatic can include patients with shortness of breath (SOB), dyspnea, chest pain (angina), orthopnea, syncope (short term loss of consciousness), and diaphoresis.

### Dofetilide

Prior studies have reported that a single dose of dofetilide, following a 10 min. infusion of 1.5 μg/kg yielded a peak plasma concentration of 1.74 ng/mL. (Sedgwick et al, Br. J. Clin Pharmacol 1991:31:515-519 and Rasmussen et al J. Cardiovascular Pharmacology 20:1992, S96-101.) An infusion of 3.0 μg/mL resulted in a plasma concentration of 5.35 ng/mL. (Sedgwick et al. and Rasmussen et al.) Coz and associates (Clin. Pharmacology & Therapeutics, 1995; 57(5) 533-54) reported that a 500 μg oral dose of dofetilide yielded a plasma concentration Cmax of 1.9 ng/mL. Thus, if a single dose reaches 70% of predicted steady state, at steady state, one can estimate Cmax ss to be 2.7 ng/mL, if 500 μg/mL was administered twice daily for at least 5 doses. If an IV dose of 1.5 μg/kg is known to result in a peak level of 1.7 ng/mL, a dose of 2.4 μg/kg, assuming linear kinetics, would reach a peak concentration of 2.7 ng/mL, exposing the patient to the peak serum concentration predicted for steady state and thus the maximum QT_{c} prolongation. This would fully expose the patient to the potentially greatest arrhythmic risk in a short period of time, while monitored in hospital.

IV dofetilide kinetics are linear permitting a direct relationship between IV dose of dofetilide administered and serum concentration obtained. With IV administration one can avoid “overshoot” in serum concentration, avoiding excessive dofetilide blood levels and thus possible arrhythmias. The relationship between serum concentration and QT_{c} interval is well known, with a high degree of correlation.

### AF/AFL Conversion

In view of the above, the invention involves a novel method of loading dofetilide to maximize patient safety by carefully obtaining a minimally requisite effective drug blood concentration ensuring that there is no excessive QT prolongation that can result in cardiac repolarization abnormalities resulting in life threatening ventricular arrhythmias.

Thus, in an aspect, the invention involves a novel method of converting atrial fibrillation (AF) or atrial flutter (AFL) in a patient who is highly symptomatic, comprising loading dofetilide intravenously (IV).

In some aspects, the IV dofetilide loading dose converts the patient to sinus rhythm. In these aspects, the patient is then switched over to oral dofetilide (e.g., BID).

In some aspects, the IV dofetilide loading dose fails to convert the patient to sinus rhythm. In these aspects, electrical cardioversion is performed. In some aspects, patients having received electrical cardioversion are unable to receive oral medication. In these aspects, an IV maintenance dose is administered until the patient can take oral medication. At that point the patient is then switched over to oral dofetilide (e.g., BID).

In another aspect, the invention involves a novel method of converting atrial fibrillation (AF) or atrial flutter (AFL) in a patient who presents with highly symptomatic AF or AFL, comprising:
a intravenously administering a loading dose of dofetilide to the patient who presents with highly symptomatic AF or AFL, wherein:
   (A) the loading dose is about 450-500 μg of dofetilide; and,
   (B) the loading dose is administered over about 30-60 minutes;
b Chemical conversion: if the patient has converted to sinus rhythm, then about 0-4 h after completion of the IV loading dose, orally administering dofetilide every 12 h, the oral dose given being based on the creatinine clearance (CrCl) of the patient as given in the following table;

| | | IV Maintenance Infusion | Oral Dose |
|---|---|---|---|
| CrCl | | (over 12 hrs) | (every 12 hrs) |
| ≥60 | mL/min | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

c Failed to chemically convert: alternatively, if the patient has not converted to sinus rhythm after completion of the IV loading infusion, then the patient is subjected to electrical cardioversion:
d about 0-1 h after electrical cardioversion, a maintenance infusion of dofetilide is infused over 3-12 h, the maintenance dose given being based on the CrCl of the patient as given in the above table based on a 12 hour infusion;
e once the patient has recovered from electrical cardioversion and able to take dofetilide orally, stopping the IV maintenance dose; and,
f about 2-6 h after stopping the IV maintenance dose, orally administering dofetilide every 12 h, the oral dose given being based on the CrCl of the patient as given in the above table;
provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

In some aspects, the QT_{c} is measured prior to administration of dofetilide to establish a baseline QT_{c} against which further QT_{c} measurements can be compared. In some aspects, during the initial infusion the QT_{c} is measured about every 15-30 minutes thereafter for 60 min and prior to the IV maintenance infusion and before each oral dose. These measurements can be discontinued once the physician observes that the patient is stable on dofetilide. For example, the QT_{c} measurements can be discontinued after the loading infusion of dofetilide is completed. Alternatively, the QT_{c} measurements can be discontinued after the first oral doses have been administered. The physician determines when to discontinue the QT_{c} measurements. Examples of a sufficient number of oral doses include 1, 2, 3, 4, 5, to 6 oral doses. After 6 oral doses steady state is typically obtained and no further change in maximal serum dofetilide concentration or QT prolongation is expected.

In another aspect, the patient is monitored via electrocardiography to determine the patient's QT_{c}.

In some aspects, the IV loading dose is about 450-500 μg of dofetilide. Examples include about 450, 455, 460, 465, 470, 475, 480, 485, 490, 495, to 500 μg of dofetilide. Typically, the loading dose chosen is an amount that achieves the predicted maximal serum concentration from orally administering 500 μg dofetilide.

In some aspects, the IV loading dose is given over about 30-60 minutes. Examples include about 30, 31, 32, 33, 34, 35, 36, 37, 38, 39, 40, 30, 41, 42, 43, 44, 45, 46, 47, 48, 49, 50, 30, 51, 52, 53, 54, 55, 56, 57, 58, 59, to 60 minutes.

A patient who is chemically converted with the IV dofetilide loading dose, can typically receive oral dofetilide.

A patient who requires electrical cardioversion, typically cannot take oral medication immediately after the procedure. In these aspects, an IV maintenance infusion of dofetilide is used employed. Once a patient is determined to have recovered enough from the electrical cardioversion to take dofetilide orally, the dofetilide IV maintenance infusion can be discontinued followed by a switch-over to oral dofetilide. It is the patient's physician or designate that determines when a patient can take dofetilide orally. Typically, a patient can take oral medication when they are awake and able to swallow with an intact gag reflex. In some aspects, this will be when the patient awakens after the procedure. In other aspects, the patient may require more time after waking to be able to swallow a pill without aspiration.

In another aspect, the IV maintenance infusion is started upon completion of the loading infusion. In another aspect, the IV maintenance infusion is started about 0, 0.5, 1, 1.5, 2, 2.5, 3, 3.5, 4, 4.5, 5, 5.5, to 6 h after completion of the loading dose.

The IV maintenance infusion, which typically is given for about 12 h, can be discontinued at any time. In another aspect, the maintenance infusion is administered for about 1, 2, 3, 4, 5, 6, 7, 8, 9, 10, 11, 12, 13, 14, 15, 16, 17, 18, 19, 20, 21, 22, 23, to 24 h. Additional examples include about 1.5, 2, 2.5, 3, 3.5, to 4 days (or sometimes longer).

The IV maintenance infusion can be discontinued if needed (e.g., due to an increase in the QT_{c}). This is an advantage of an IV versus an oral treatment. The IV maintenance infusion can be quickly stopped if the patient is having an adverse effect to dofetilide.

The IV maintenance infusion given is dependent upon the CrCl of the patient, as shown in the table below.

IV Maintenance Infusion of Dofetilide

| | | IV Maintenance Infusion of |
|---|---|---|
| Creatinine Clearance (CrCl) | | (over 12 h) |
| 60 | mL/min or more | 450-500 μg |
| 40-<60 | mL/min | 225-250 μg |
| 20-<40 | mL/min | 100-125 μg |
| <20 | mL/min | Dofetilide not indicated |

For a patient with a CrCl of >60 mL/min, the IV maintenance dose is typically about 450-500 μg of dofetilide and is typically given over about 12 h (but can vary as noted above). Examples include about 450, 455, 460, 465, 470, 475, 480, 485, 490, 495, to 500 μg of dofetilide. This equates to about 0.625-0.694 μg/min of dofetilide (450/720 to 500/720). In another aspect, the IV maintenance dose is about 0.6, 0.61, 0.62, 0.63, 0.64, 0.65, 0.66, 0.67, 0.68, 0.69, to 0.7 μg/min.

For a patient with a CrCl of 40-<60 mL/min, the IV maintenance dose is typically about 225-250 μg of dofetilide and is typically given over about 12 h (but can vary as noted above). Examples include about 225, 230, 235, 240, 245, to 250 μg of dofetilide. This equates to about 0.313-0.347 μg/min of dofetilide (225/720 to 250/720). In another aspect, the IV maintenance dose is about 0.3, 0.31, 0.32, 0.33, 0.34, to 0.35 μg/min.

For a patient with a CrCl of 20-<40 mL/min, the IV maintenance dose is typically about 100-125 μg of dofetilide and is typically given over about 12 h (but can vary as noted above). Examples include about 100, 105, 110, 115, 120, to 125 μg of dofetilide. This equates to about 0.139-0.174 μg/min of dofetilide (100/720 to 125/720). In another aspect, the IV maintenance dose is about 0.13, 0.14, 0.15, 0.16, 0.17, to 0.18 μg/min.

In another aspect, the oral dose is started about 1, 2, 3, 4, 5, 6, 7, 8, 9, to 10 hours after the maintenance dose has been stopped. In another aspect, the oral dose is started about 3-6 hours after the maintenance dose has been stopped.

Oral dofetilide is available in capsule form in three sizes, 125, 250, and 500 μg. In another aspect, the patient is given dofetilide orally BID (once every 12 hours). Examples of these doses include 125, 250, 375 (e.g., 3×125 capsules or 125+250 capsules), and 500 μg.

The standard dose for patients having a creatinine clearance (CrCl)(or calculated GFR (glomerular filtration rate)) of >60 mL/min is 500 μg. However, per the table below, this dose is lowered if the patient's CRCL is <60 mL/min.

| Creatinine Clearance (CrCl) | | Starting Oral Dose of Dofetilide |
|---|---|---|
| ≥60 | mL/min | 500 μg bid |
| 40-<60 | mL/min | 250 μg bid |
| 20-<40 | mL/min | 125 μg bid |
| <20 | mL/min | Dofetilide not indicated |

The oral dose of dofetilide is also reduced if warranted by the patient's QT_{c}. For example, if the patient's QT_{c} increases by 15% over the baseline QT_{c} or if the QT_{c} is measured to be >500 msec or >550 msec in patients with ventricular conduction abnormalities, the oral dose of dofetilide is reduced to 250 μg from 500 μg, or 125 μg from 250 μg, or discontinued if the original dose was 125 μg.

For a patient with a CrCl of ≥60 mL/min, the twice-daily oral doses of dofetilide are 500 μg. In this aspect, the oral doses are reduced to 250 μg if the patient's QT_{c} increased by 15% over baseline QT_{c} or if the QTc is measured to be >500 msec or >550 msec if the patient has a ventricular conduction abnormality.

For a patient with a CrCl of 40-<60 mL/min, the twice-daily oral doses of dofetilide are 250 μg. In this aspect, the oral doses are reduced to 125 μg if the patient's QT_{c} increased by 15% over baseline QT_{c} or if the QTc is measured to be >500 msec or >550 msec if the patient has a ventricular conduction abnormality.

For a patient with a CrCl of 20-<40 mL/min, the twice-daily oral doses of dofetilide are 125 μg. In this aspect, the treatment is discontinued if the patient's QT_{c} is increased by 15% over baseline QT_{c} or if the QTc is measured to be >500 msec or >550 msec if the patient has a ventricular conduction abnormality.

In an alternative aspect, a patient with a CrCl of 20-<40 mL/min is given 125 μg of dofetilide orally once daily. This once-daily regimen is selected based on the judgment of the patient's physician. In this aspect, the treatment is discontinued if the patient's QT_{c} is increased by 15% over baseline QT_{c} or if the QTc is measured at >500 msec or >550 msec if the patient has a ventricular conduction abnormality.

In another aspect, the patient has a CrCl of ≥60 mL/min, the IV maintenance dose is about 450-500 μg of dofetilide and is given over about 12 h and the twice-daily oral doses of dofetilide are 500 μg. In this aspect, the oral doses are reduced to 250 μg if the patient's QT_{c} increased by 15% over baseline QT_{c} or if the QTc is measured to be >500 msec or >550 msec if the patient has a ventricular conduction abnormality.

In another aspect, the patient has a CrCl of 40-<60 mL/min, the IV maintenance dose is about 225-250 μg of dofetilide and is given over about 12 h and the twice-daily oral doses of dofetilide are 250 μg. In this aspect, the oral doses are reduced to 125 μg if the patient's QT_{c} increased by 15% over baseline QT_{c} or if the QTc is measured to be >500 msec or >550 msec if the patient has a ventricular conduction abnormality.

In another aspect, the patient has a CrCl of 20-<40 mL/min, the IV maintenance dose is about 100-125 μg of dofetilide and is given over about 12 h and the twice-daily oral doses of dofetilide are 125 μg. In this aspect, the treatment is discontinued if the patient's QT_{c} is increased by 15% over baseline QT_{c} or if the QTc is measured to be >500 msec or >550 msec if the patient has a ventricular conduction abnormality.

In an alternative aspect, the patient has a CrCl of 20-<40 mL/min, the IV maintenance dose is about 100-125 μg of dofetilide and is given over about 12 h, and the once-daily oral dose of dofetilide is 125 μg. In this aspect, the treatment is discontinued if the patient's QT_{c} is increased by 15% over baseline QT_{c} or if the QTc is measured to be >500 msec or >550 msec if the patient has a ventricular conduction abnormality.

Suitable intravenous formulations are described in U.S. Pat. No. 11,364,213.

Examples of the concentration of a useful dofetilide intravenous solution includes about 1, 2, 3, 4, 5, 10, 15, 20, 25, 30, 35, 40, 45, 50, 55, 60, 65, 70, 75, 80, 85, 90, 95 to 100 μg/mL.

The invention may be embodied in other specific forms without departing from the spirit or essential attributes thereof. This invention encompasses all combinations of aspects of the invention noted herein. It is understood that any and all embodiments of the invention may be taken in conjunction with any other embodiment or embodiments to describe additional embodiments. It is also to be understood that each individual element of the embodiments is intended to be taken individually as its own independent embodiment. Furthermore, any element of an embodiment is meant to be combined with any and all other elements from any embodiment to describe an additional embodiment.

Other features of the invention will become apparent in the course of the following descriptions of exemplary embodiments that are given for illustration of the invention and are not intended to be limiting thereof.

### EXAMPLES

### Example 5

A 70 kg patient with a CrCl>60 mL/min presents with highly symptomatic atrial fibrillation (AF) and the patient's physician decides that the AF needs to be terminated with an infusion of dofetilide. The patient is admitted to the hospital and has continuously monitored ECG.

Chemical Cardioversion with Dofetilide:

The patient is then subjected to the following treatment with dofetilide.
(G) Hour 0: Intravenous (IV) Loading Dose: 450 μg, infusion over 1 h measuring QT_{c}, HR, and BP every 15 minutes; and
(H) Hour 1: Oral Dose: if the patent converts from the IV loading dose, then 500 μg is given orally every 12 hours (BID), started 1 h after the start of the IV loading infusion.

### Electrical Cardioversion:

The patient is then subjected to the following treatment with dofetilide.
(A) Hour 0: Intravenous (IV) Loading Dose: 450 μg, infusion over 1 h measuring QT_{c}, HR, and BP every 15 minutes;
(B) Hour 1: Electrical Cardioversion. If the patient has not converted from the dofetilide IV loading dose, then the patient is the subjected to electrical cardioversion to convert to sinus rhythm.
(C) Hour 1.5: IV Maintenance Dose: optionally, after electrical cardioversion, a 450 μg, 3-6 h infusion is started. This maintenance dose is stopped once the patient can take oral medication; and,
(D) Hour 4-7: Oral Dose: 500 μg given orally every 12 hours (BID), started once the converted patient can receive oral medication-typically about 4-7 h after initiation of IV loading.

FIG. 1 below shows the estimated blood dofetilide concentration obtained with the above described dosage regimen. This graph was obtained by modeling the above dosage regimen. The software packages NONMEM™ version 7.4 (ICON, Hanover, MD, USA) and MWpharm (Mediware, Prague, CZ) 6 were used for the Bayesian PK modeling. PsN7 (Dept. of Pharmacy, Uppsala University, Uppsala, Sweden) was used for automation procedures. R (version 3.5.1, The R Foundation for Statistical Computing) was used for data preparation, graphical analysis, linear regression analysis, and statistical summaries. R package ‘mrgsolve’ was used for simulations.

Step (A): the loading dose, which in this example is a 450 μg IV infusion of dofetilide over 1 h, is expected to achieve the predicted maximal serum concentration that one would expect from 500 μg-dofetilide chronically dosed orally. Oral dosing would reach peak, after 6 doses twice daily of dofetilide. The peak dofetilide concentration will be reached at termination of infusion.

QT_{c} would be measured every 15 mins during the infusion.

Step (B): the IV maintenance dose of a 450 μg IV infusion of dofetilide over 12 h (0.625 μg/min) is initiated at the end of the 1 h loading IV. This dose can be maintained until the patient is awake and able to take dofetilide orally.

Once the patient can take dofetilide orally, the dofetilide maintenance IV is stopped. Starting about 3 h after stopping the maintenance IV, an oral dose of 500 μg of dofetilide is administered every 12 h (BID).

If the QT_{c} has increased by 15% over baseline QT_{c} or if a QT_{c}>500 msec is observed (550 msec in patients with ventricular conduction abnormalities), subsequent oral doses would be reduced to 250 μg BID (or lower if the original oral dose called for is lower, see below).

It is noted that if patients present with a lower than normal CrCl, the initial target concentration would be the same, but the oral (maintenance) dose administered would be lower; 250 μg or 125 μg BID (based on the chart below).

| Creatinine Clearance (CrCl) | | Oral Dose of Dofetilide |
|---|---|---|
| ≥60 | mL/min | 500 μg bid |
| 40-<60 | mL/min | 250 μg bid |
| 20-<40 | mL/min | 125 μg bid |
| <20 | mL/min | Dofetilide not indicated |

Further, in patients that show excessive QT_{c} prolongation at initial loading (>500 msec or >550 msec in patients with ventricular conduction abnormalities), the first oral dose would be reduced to 250 μg (or 125 μg if starting oral dose was 250 μg based on the above chart) and the peak concentration expected in 4 h with QT_{c} re-evaluated. The longest QTc will be measured at peak concentration at the end of the loading infusion and will be the same peak seen with chronic oral dosing of 250 μg. This would permit the measurement of the QTc response at the highest dofetilide concentration projected that the patient would be exposed to chronically to maintain normal sinus rhythm, thus establishing safety of chronic dofetilide dosing.

### Example 6

A 75 kg patient with a CrCl of 45 mL/min presents with highly symptomatic atrial fibrillation (AF) and the patient's physician decides that the AF needs to be terminated with an infusion of dofetilide. The patient is admitted to the hospital and has an ECG continuously monitored.

Chemical Cardioversion with Dofetilide:

The patient is then subjected to the following treatment with dofetilide.
(A) Hour 0: Intravenous (IV) Loading Dose: 450 μg, infusion over 1 h measuring QT_{c}, HR, and BP every 15 minutes; and
(B) Hour 1: Oral Dose: if the patent converts from the IV loading dose, then 250 μg is given orally every 12 hours (BID), started 1 h after the start of the IV loading infusion.

### Electrical Cardioversion:

The patient is then subjected to the following treatment with dofetilide.
(A) Hour 0: Intravenous (IV) Loading Dose: 450 μg, infusion over 1 h measuring QT_{c}, HR, and BP every 15 minutes;
(B) Hour 1: Electrical Cardioversion. If the patient has not converted from the dofetilide IV loading dose, then the patient is subjected to electrical cardioversion to convert to sinus rhythm.
(C) Hour 1.5: IV Maintenance Dose: optionally, after electrical cardioversion, a 225 μg, 3-6 h infusion is started. This maintenance dose is stopped once the patient can take oral medication; and,
(D) Hour 4-7: Oral Dose: 250 μg given orally every 12 hours (BID), started once the converted patient can receive oral medication-typically about 4-7 h after initiation of IV loading.

### EMBODIMENTS—C. INTRAVENOUS DOFETILIDE TO CONVERT ATRIAL FIBRILLATION/FLUTTER

Embodiment 1: A method of converting atrial fibrillation (AF) or atrial flutter (AFL) in a patient who presents with highly symptomatic AF or AFL, comprising:
a intravenously administering a loading dose of dofetilide to the patient who presents with highly symptomatic AF or AFL, wherein:
   (A) the loading dose is about 450-500 μg of dofetilide; and,
   (B) the loading dose is administered over about 30-60 minutes;
b if the patient has converted to sinus rhythm, then about 0-4 h after completion of the IV loading dose, orally administering dofetilide every 12 h, the oral dose given being based on the creatinine clearance (CrCl) of the patient as given in the following table:

| | | IV Maintenance Dose | Oral Dose |
|---|---|---|---|
| CrCl | | (over 12 h) | (every 12 h) |
| ≥60 | mL/min | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

c if the patient has not converted to sinus rhythm after completion of the IV loading infusion, then subjecting the patient to electrical cardioversion:
d about 0-1 h after conversion with electrical cardioversion, intravenously administering a maintenance dose of dofetilide over about 3-12 h, the maintenance dose given being based on the CrCl of the patient as given in the above table based on a 12 h infusion;
c once the patient has recovered from electrical cardioversion and able to take dofetilide orally, stopping the IV maintenance dose; and,
f about 2-6 h after stopping the IV maintenance dose, orally administering dofetilide every 12 h, the oral dose given being based on the CrCl of the patient as given in the above table;
provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

Embodiment 2: The method of Embodiment 1, further comprising:
measuring the QT_{c} of the patient prior to the IV loading dose of dofetilide to establish a baseline QT_{c} and then measuring the QT_{c} about every 15-30 minutes thereafter for 60 min and prior to the IV maintenance infusion and before each oral dose.

Embodiment 3: The method of Embodiment 1, wherein the loading dose is about 450 μg.

Embodiment 4: The method of Embodiment 1, wherein the loading dose is about 460 μg.

Embodiment 5: The method of Embodiment 1, wherein the loading dose is about 470 μg.

Embodiment 6: The method of Embodiment 1, wherein the loading dose is about 480 μg.

Embodiment 7: The method of Embodiment 1, wherein the loading dose is about 490 μg.

Embodiment 8: The method of Embodiment 1, wherein the loading dose is about 500 μg.

Embodiment 9: The method of Embodiment 1, wherein the loading dose is administered over about 30 minutes.

Embodiment 10: The method of Embodiment 1, wherein the loading dose is administered over about 40 minutes.

Embodiment 11: The method of Embodiment 1, wherein the loading dose is administered over about 50 minutes.

Embodiment 12: The method of Embodiment 1, wherein the loading dose is administered over about 60 minutes.

Embodiment 13: The method of Embodiment 1, wherein the maintenance dose is started about 0 h after completion of the loading dose.

Embodiment 14: The method of Embodiment 1, wherein the maintenance dose is started about 1 h after completion of the loading dose.

Embodiment 15: The method of Embodiment 1, wherein the maintenance dose is started about 2 h after completion of the loading dose.

Embodiment 16: The method of Embodiment 1, wherein the maintenance dose is started about 3 h after completion of the loading dose.

Embodiment 17: The method of Embodiment 1, wherein the maintenance dose is started about 4 h after completion of the loading dose.

Embodiment 18: The method of Embodiment 1, wherein the patient has a CrCl of ≥60 mL/min, the IV maintenance dose is about 450-500 μg given over about 12 h and the oral doses are 500 μg.

Embodiment 19: The method of Embodiment 18, wherein the oral doses are reduced to 250 μg due to a QTc that increased by 15% over baseline QTc or if the QTc is measured at >500 msec or >550 msec if the patient has a ventricular conduction abnormality.

Embodiment 20: The method of Embodiment 1, wherein the patient has a CrCl of 40-<60 mL/min, the IV maintenance dose is about 225-250 μg given over about 12 h and the oral doses are 250 μg.

Embodiment 21: The method of Embodiment 20, wherein the oral doses are reduced to 125 μg due to a QTc that increased by 15% over baseline QTc or if the QTc is measured at >500 msec or >550 msec if the patient has a ventricular conduction abnormality.

Embodiment 22: The method of Embodiment 1, wherein the patient has a CrCl of 20-<40 mL/min, the IV maintenance dose is about 100-125 μg given over about 12 h and the oral doses are 125 μg.

Embodiment 23: The method of Embodiment 22, wherein the oral doses are discontinued due to a QTc that increased by 15% over baseline QTc or if the QTc is measured at >500 msec is observed or >550 msec if the patient has a ventricular conduction abnormality.

### FURTHER EMBODIMENTS—C. INTRAVENOUS DOFETILIDE TO CONVERT ATRIAL FIBRILLATION/FLUTTER

Embodiment 1: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes; and
b. about 0-4 hours after completion of the loading dose, orally administering 500 μg dofetilide every 12 hours to a patient that has converted to sinus rhythm who has a creatine clearance of 60 mL/min or higher;
   wherein the oral dofetilide dose is reduced to 250 μg for those patients with an increased QTc of 15% over baseline, those patients having a QTc>500 msec, or for those patients with a ventricular conduction abnormality having a QTc of >550 msec; and wherein the loading dose is expected to achieve maximum serum concentration at the termination of the infusion; and
   wherein the patient is monitored to ensure no excessive QT prolongation results in cardiac repolarization abnormalities which cause life threatening ventricular arrhythmias.

Embodiment 2: The method of embodiment 1, which is a method of converting atrial fibrillation (AF) or atrial flutter (AFL).

Embodiment 3: The method of embodiment 1, wherein patients who are highly symptomatic have severe hemodynamic compromise. with symptoms which can include shortness of breath, dyspnea, chest pain (angina), orthopnea, syncope, and diaphoresis.

Embodiment 4: The method of embodiment 1, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 5: The method of embodiment 4, wherein the patient's physician determines when the patient is stable.

Embodiment 6: The method of embodiment 5, wherein the patient may be stable after the loading infusion of dofetilide is complete. or after the first oral doses have been administered.

Embodiment 7: The method of embodiment 1, wherein the loading dose is 450-500 μg dofetilide −500 μg dofetilide.

Embodiment 8: The method of embodiment 1, wherein 1-3 hours after completion of the loading dose, a maintenance dose (“the IV maintenance dose”) of 450-500 μg dofetilide is administered to those patients having a creatine clearance of 60 mL/min or higher.

Embodiment 9: The method of embodiment 1, wherein the creatine clearance is 60 mL/min or higher.

Embodiment 10: The method of embodiment 1, wherein the intravenous loading dose is administered over about 30-60 minutes.

Embodiment 11: The method of embodiment 1, further comprising measuring the patient's creatine clearance as an approximation of the glomerular filtration rate (GFR), prior to orally administering dofetilide, to determine the amount of dofetilide indicated for the oral dose.

Embodiment 12: The method of embodiment 1, wherein the dofetilide is fully loaded in less than three days.

Embodiment 13: The method of embodiment 12, wherein the dofetilide is fully loaded when it reaches steady state concentration in the blood.

Embodiment 14: The method of embodiment 1, wherein intravenous dofetilide administration prevents possible arrythmias by avoiding excessive dofetilide blood levels.

Embodiment 15: A method of treating patients who present with highly symptomatic atrial fibrillation (AF) or atrial flutter (AFL), comprising:
c. intravenously administering to a patient in need thereof a loading dose of about 450-500 μg dofetilide over about 30-60 minutes; and
d. about 0-4 hours after completion of the loading dose, orally administering 250 μg dofetilide every 12 hours to a patient that has converted to sinus rhythm who has a creatine clearance of 40-<60 mL/min;
wherein the oral dofetilide dose is reduced to 125 μg for those patients with an increased QTc of 15% over baseline, those patients having a QTc>500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 16: The method of embodiment 15, which is a method of converting atrial fibrillation (AF) or atrial flutter (AFL).

Embodiment 17: The method of embodiment 15, wherein patients who are highly symptomatic have severe hemodynamic compromise, with symptoms which can include shortness of breath, dyspnea, chest pain (angina). orthopnea, syncope, and diaphoresis.

Embodiment 18: The method of embodiment 15, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 19: The method of embodiment 18, wherein the patient's physician determines when the patient is stable.

Embodiment 20: The method of embodiment 19, wherein the patient may be stable after the loading infusion of dofetilide is complete, or after the first oral doses have been administered.

Embodiment 21: The method of embodiment 15, wherein the loading dose is 450-500 μg dofetilide −500 μg dofetilide.

Embodiment 22: The method of embodiment 15, wherein 1-3 hours after completion of the loading dose, a maintenance dose (“the IV maintenance dose”) of 450-500 μg dofetilide is administered to those patients having a creatine clearance of 60 mL/min or higher.

Embodiment 23: The method of embodiment 15, wherein the intravenous loading dose is administered over about 30-60 minutes.

Embodiment 24: The method of embodiment 15, further comprising measuring the patient's creatine clearance as an approximation of the glomerular filtration rate (GFR), prior to orally administering dofetilide, to determine the amount of dofetilide indicated for the oral dose.

Embodiment 25: The method of embodiment 15, wherein the dofetilide is fully loaded in less than three days.

Embodiment 26: The method of embodiment 25, wherein the dofetilide is fully loaded when it reaches steady state concentration in the blood.

Embodiment 27: The method of embodiment 15, wherein intravenous dofetilide administration prevents possible arrythmias by avoiding excessive dofetilide blood levels.

Embodiment 28: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes; and
b. about 0-4 hours after completion of the loading dose, orally administering 125 μg dofetilide every 12 hours to a patient that has converted to sinus rhythm who has a creatine clearance of 20-<40 mL/min;
wherein the oral dofetilide dose is discontinued for those patients with an increased QTc of 15% over baseline, those patients having a QTc>500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 29: The method of embodiment 28, which is a method of converting atrial fibrillation (AF) or atrial flutter (AFL).

Embodiment 30: The method of embodiment 28, wherein patients who are highly symptomatic have severe hemodynamic compromise, with symptoms which can include shortness of breath, dyspnea, chest pain (angina). orthopnea, syncope, and diaphoresis.

Embodiment 31: The method of embodiment 28, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 32: The method of embodiment 31, wherein the patient's physician determines when the patient is stable.

Embodiment 33: The method of embodiment 32, wherein the patient may be stable after the loading infusion of dofetilide is complete, or after the first oral doses have been administered.

Embodiment 34: The method of embodiment 28, wherein the loading dose is 450-500 μg dofetilide.

Embodiment 35: The method of embodiment 28, wherein 1-3 hours after completion of the loading dose, a maintenance dose (“the IV maintenance dose”) of 450-500 μg dofetilide is administered to those patients having a creatine clearance of 60 mL/min or higher.

Embodiment 36: The method of embodiment 28, wherein the intravenous loading dose is administered over about 30-60 minutes.

Embodiment 37: The method of embodiment 28, further comprising measuring the patient's creatine clearance as an approximation of the glomerular filtration rate (GFR), prior to orally administering dofetilide, to determine the amount of dofetilide indicated for the oral dose.

Embodiment 38: The method of embodiment 28, wherein the dofetilide is fully loaded in less than three days.

Embodiment 39: The method of embodiment 38, wherein the dofetilide is fully loaded when it reaches steady state concentration in the blood.

Embodiment 40: The method of embodiment 28, wherein intravenous dofetilide administration prevents possible arrythmias by avoiding excessive dofetilide blood levels.

Embodiment 41: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 450-500 μg dofetilide over about 3-12 hours to those patients having a creatine clearance of 60 mL/min or higher;
d. discontinuing the IV maintenance dose for patients who have sufficiently recovered from the electrical cardioversion; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 42: The method of embodiment 41, which is a method of converting atrial fibrillation (AF) or atrial flutter (AFL).

Embodiment 43: The method of embodiment 41, wherein patients who are highly symptomatic have severe hemodynamic compromise, with symptoms which can include shortness of breath, dyspnea, chest pain (angina). orthopnea, syncope, and diaphoresis.

Embodiment 44: The method of embodiment 41, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 45: The method of embodiment 44, wherein the patient's physician determines when the patient is stable.

Embodiment 46: The method of embodiment 45, wherein the patient may be stable after the loading infusion of dofetilide is complete, or after the first oral doses have been administered.

Embodiment 47: The method of embodiment 41, wherein the loading dose is 450-500 μg dofetilide.

Embodiment 48: The method of embodiment 41, wherein 1-3 hours after completion of the loading dose, a maintenance dose (“the IV maintenance dose”) of 450-500 μg dofetilide is administered to those patients having a creatine clearance of 60 mL/min or higher.

Embodiment 49: The method of embodiment 41, wherein the IV maintenance dose is about 450-500 μg dofetilide.

Embodiment 50: The method of embodiment 41, wherein the creatine clearance is 60 mL/min or higher.

Embodiment 51: The method of embodiment 41, wherein 3-5 hours after discontinuing the IV maintenance dose dofetilide is administered orally.

Embodiment 52: The method of embodiment 41, further comprising measuring the patient's creatine clearance as an approximation of the glomerular filtration rate (GFR), prior to administering the IV maintenance dose, to determine the amount of dofetilide indicated for the IV maintenance dose.

Embodiment 53: The method of embodiment 41, further comprising measuring the patient's creatine clearance as an approximation of the glomerular filtration rate (GFR), prior to orally administering dofetilide, to determine the amount of dofetilide indicated for the oral dose.

Embodiment 54: The method of embodiment 41, wherein the patient has sufficiently recovered from the electrical cardioversion and is orally administered dofetilide when awake after surgery with an intact gag reflex.

Embodiment 55: The method of embodiment 41, wherein the intravenous loading dose is administered over about 30-60 minutes.

Embodiment 56: The method of embodiment 41, wherein the IV maintenance dose is administered over about 3-12 hours.

Embodiment 57: The method of embodiment 41, wherein the dofetilide is fully loaded in less than three days.

Embodiment 58: The method of embodiment 57, wherein the dofetilide is fully loaded when it reaches steady state concentration in the blood.

Embodiment 59: The method of embodiment 41, wherein the intravenous dofetilide is administered in a first loading dose and an ongoing IV maintenance dose.

Embodiment 60: The method of embodiment 41, wherein intravenous dofetilide administration prevents possible arrythmias by avoiding excessive dofetilide blood levels.

Embodiment 61: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patient who have not converted to sinus rhythm;
c. about 0-1 hour after conversion with electrical cardioversion, intravenously administering a maintenance dose (“the IV maintenance dose”) of 450-500 μg dofetilide over about 3-12 hours to those patients having a creatine clearance of 60 mL/min or higher;
d. discontinuing the IV maintenance dose for patients who have sufficiently recovered from the electrical cardioversion; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 62: The method of embodiment 61, which is a method of converting atrial fibrillation (AF) or atrial flutter (AFL).

Embodiment 63: The method of embodiment 61, wherein patients who are highly symptomatic have severe hemodynamic compromise, with symptoms which can include shortness of breath, dyspnea, chest pain (angina), orthopnea, syncope, and diaphoresis.

Embodiment 64: The method of embodiment 61, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 65: The method of embodiment 64, wherein the patient's physician determines when the patient is stable.

Embodiment 66: The method of embodiment 65, wherein the patient may be stable after the loading infusion of dofetilide is complete, or after the first oral doses have been administered.

Embodiment 67: The method of embodiment 61, wherein the loading dose is 450-500 μg dofetilide.

Embodiment 68: The method of embodiment 61, wherein 1-3 hours after completion of the loading dose, a maintenance dose (“the IV maintenance dose”) of 450-500 pg dofetilide is administered to those patients having a creatine clearance of 60 mL/min or higher.

Embodiment 69: The method of embodiment 61, wherein the IV maintenance dose is about 450-500 μg dofetilide.

Embodiment 70: The method of embodiment 61, wherein the creatine clearance is 60 mL/min or higher.

Embodiment 71: The method of embodiment 61, wherein the about 2-6 hours after discontinuing the IV maintenance dose.

Embodiment 72: The method of embodiment 61, further comprising measuring the patient's creatine clearance as an approximation of the glomerular filtration rate (GFR), prior to administering the IV maintenance dose, to determine the amount of dofetilide indicated for the IV maintenance dose.

Embodiment 73: The method of embodiment 61, further comprising measuring the patient's creatine clearance as an approximation of the glomerular filtration rate (GFR), prior to orally administering dofetilide, to determine the amount of dofetilide indicated for the oral dose.

Embodiment 74: The method of embodiment 61, wherein the patient has sufficiently recovered from the electrical cardioversion and is orally administered dofetilide when awake after surgery with an intact gag reflex.

Embodiment 75: The method of embodiment 61, wherein the intravenous loading dose is administered over about 30-60 minutes.

Embodiment 76: The method of embodiment 61, wherein the IV maintenance dose is administered over about 3-12 hours.

Embodiment 77: The method of embodiment 61, wherein the dofetilide is fully loaded in less than three days.

Embodiment 78: The method of embodiment 77, wherein the dofetilide is fully loaded when it reaches steady state concentration in the blood.

Embodiment 79: The method of embodiment 61, wherein the intravenous dofetilide is administered in a first loading dose and an ongoing IV maintenance dose.

Embodiment 80: The method of embodiment 61, wherein intravenous dofetilide administration prevents possible arrythmias by avoiding excessive dofetilide blood levels.

Embodiment 81: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 450-500 μg dofetilide over about 3-12 hours to those patients having a creatine clearance of 60 mL/min or higher;
d. discontinuing the IV maintenance dose for patients who have sufficiently recovered from the electrical cardioversion; and
e. about 2-6 hours after discontinuing the IV maintenance dose, orally administering 125 μg dofetilide every 12 hours to those patients having a 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 82: The method of embodiment 81, which is a method of converting atrial fibrillation (AF) or atrial flutter (AFL).

Embodiment 83: The method of embodiment 81, wherein patients who are highly symptomatic have severe hemodynamic compromise, with symptoms which can include shortness of breath, dyspnea, chest pain (angina), orthopnea, syncope, and diaphoresis.

Embodiment 84: The method of embodiment 81, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 85: The method of embodiment 84, wherein the patient's physician determines when the patient is stable.

Embodiment 86: The method of embodiment 85, wherein the patient may be stable after the loading infusion of dofetilide is complete. or after the first oral doses have been administered.

Embodiment 87: The method of embodiment 81, wherein the loading dose is 450-500 μg dofetilide.

Embodiment 88: The method of embodiment 81, wherein 1-3 hours after completion of the loading dose, a maintenance dose (“the IV maintenance dose”) of 450-500 μg dofetilide is administered to those patients having a creatine clearance of 60 mL/min or higher.

Embodiment 89: The method of embodiment 81, wherein the IV maintenance dose is 450-500 μg dofetilide.

Embodiment 90: The method of embodiment 81, wherein the creatine clearance is 60 mL/min or higher.

Embodiment 91: The method of embodiment 81, wherein 3-5 hours after discontinuing the IV maintenance dose, 500 μg dofetilide is orally administered every 12 hours to those patients having a creatine clearance of 60 mL/min or higher.

Embodiment 92: The method of embodiment 81, further comprising measuring the patient's creatine clearance as an approximation of the glomerular filtration rate (GFR), prior to administering the IV maintenance dose, to determine the amount of dofetilide indicated for the IV maintenance dose.

Embodiment 93: The method of embodiment 81, further comprising measuring the patient's creatine clearance as an approximation of the glomerular filtration rate (GFR), prior to orally administering dofetilide, to determine the amount of dofetilide indicated for the oral dose.

Embodiment 94: The method of embodiment 81, wherein the patient has sufficiently recovered from the electrical cardioversion and is orally administered dofetilide when awake after surgery with an intact gag reflex.

Embodiment 95: The method of embodiment 81, wherein the intravenous loading dose is administered over about 30-60 minutes.

Embodiment 96: The method of embodiment 81, wherein the IV maintenance dose is administered over about 3-12 hours.

Embodiment 97: The method of embodiment 81, wherein the dofetilide is fully loaded in less than three days.

Embodiment 98: The method of embodiment 97, wherein the dofetilide is fully loaded when it reaches steady state concentration in the blood.

Embodiment 99: The method of embodiment 81, wherein the intravenous dofetilide is administered in a first loading dose and an ongoing IV maintenance dose.

Embodiment 100: The method of embodiment 81, wherein intravenous dofetilide administration prevents possible arrythmias by avoiding excessive dofetilide blood levels.

Embodiment 101: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 225-250 μg dofetilide over about 3-12 hours to those patients having a creatine clearance of 40-<60 mL/min;
d. discontinuing the IV maintenance dose for patients who have sufficiently recovered from the electrical cardioversion; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 102: The method of embodiment 101, which is a method of converting atrial fibrillation (AF) or atrial flutter (AFL).

Embodiment 103: The method of embodiment 101, wherein patients who are highly symptomatic have severe hemodynamic compromise, with symptoms which can include shortness of breath, dyspnea, chest pain (angina). orthopnea, syncope, and diaphoresis.

Embodiment 104: The method of embodiment 101, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 105: The method of embodiment 104, wherein the patient's physician determines when the patient is stable.

Embodiment 106: The method of embodiment 105, wherein the patient may be stable after the loading infusion of dofetilide is complete, or after the first oral doses have been administered.

Embodiment 107: The method of embodiment 101, wherein the loading dose is 450-500 μg dofetilide.

Embodiment 108: The method of embodiment 101, wherein 1-3 hours after completion of the loading dose, a maintenance dose (“the IV maintenance dose”) of 450-500 μg dofetilide is administered to those patients having a creatine clearance of 60 mL/min or higher.

Embodiment 109: The method of embodiment 101, wherein the IV maintenance dose is 225-250 μg dofetilide.

Embodiment 110: The method of embodiment 101, wherein the creatine clearance is 60 mL/min or higher.

Embodiment 111: The method of embodiment 101, wherein 3-5 hours after discontinuing the IV maintenance dose, 500 μg dofetilide is orally administered every 12 hours to those patients having a creatine clearance of 60 mL/min or higher.

Embodiment 112: The method of embodiment 101, further comprising measuring the patient's creatine clearance as an approximation of the glomerular filtration rate (GFR), prior to administering the IV maintenance dose, to determine the amount of dofetilide indicated for the IV maintenance dose.

Embodiment 113: The method of embodiment 101, further comprising measuring the patient's creatine clearance as an approximation of the glomerular filtration rate (GFR), prior to orally administering dofetilide, to determine the amount of dofetilide indicated for the oral dose.

Embodiment 114: The method of embodiment 101, wherein the patient has sufficiently recovered from the electrical cardioversion and is orally administered dofetilide when awake after surgery with an intact gag reflex.

Embodiment 115: The method of embodiment 101, wherein the intravenous loading dose is administered over about 30-60 minutes.

Embodiment 116: The method of embodiment 101, wherein the IV maintenance dose is administered over about 3-12 hours.

Embodiment 117: The method of embodiment 101, wherein the dofetilide is fully loaded in less than three days.

Embodiment 118: The method of embodiment 117, wherein the dofetilide is fully loaded when it reaches steady state concentration in the blood.

Embodiment 119: The method of embodiment 101, wherein the intravenous dofetilide is administered in a first loading dose and an ongoing IV maintenance dose.

Embodiment 120: The method of embodiment 101, wherein intravenous dofetilide administration prevents possible arrythmias by avoiding excessive dofetilide blood levels.

Embodiment 121: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 225-250 μg dofetilide over about 3-12 hours to those patients having a creatine clearance of 40-<60 mL/min;
d. discontinuing the IV maintenance dose for patients who have sufficiently recovered from the electrical cardioversion; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 122: The method of embodiment 121, which is a method of converting atrial fibrillation (AF) or atrial flutter (AFL).

Embodiment 123: The method of embodiment 121, wherein patients who are highly symptomatic have severe hemodynamic compromise, with symptoms which can include shortness of breath, dyspnea, chest pain (angina). orthopnea, syncope, and diaphoresis.

Embodiment 124: The method of embodiment 121, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 125: The method of embodiment 124, wherein the patient's physician determines when the patient is stable.

Embodiment 126: The method of embodiment 125, wherein the patient may be stable after the loading infusion of dofetilide is complete, or after the first oral doses have been administered.

Embodiment 127: The method of embodiment 121, wherein the loading dose is 450-500 μg dofetilide.

Embodiment 128: The method of embodiment 121, wherein the wherein 1-3 hours after completion of the loading dose, a maintenance dose (“the IV maintenance dose”) of 450-500 μg dofetilide is administered to those patients having a creatine clearance of 60 mL/min or higher.

Embodiment 129: The method of embodiment 121, wherein the IV maintenance dose is 225-250 μg dofetilide.

Embodiment 130: The method of embodiment 121, wherein 3-5 hours after discontinuing the IV maintenance dose, 500 μg dofetilide is orally administered every 12 hours to those patients having a creatine clearance of 60 mL/min or higher.

Embodiment 131: The method of embodiment 121, further comprising measuring the patient's creatine clearance as an approximation of the glomerular filtration rate (GFR), prior to administering the IV maintenance dose, to determine the amount of dofetilide indicated for the IV maintenance dose.

Embodiment 132: The method of embodiment 121, further comprising measuring the patient's creatine clearance as an approximation of the glomerular filtration rate (GFR), prior to orally administering dofetilide, to determine the amount of dofetilide indicated for the oral dose.

Embodiment 133: The method of embodiment 121, wherein the patient has sufficiently recovered from the electrical cardioversion and is orally administered dofetilide when awake after surgery with an intact gag reflex.

Embodiment 134: The method of embodiment 121, wherein the intravenous loading dose is administered over about 30-60 minutes.

Embodiment 135: The method of embodiment 121, wherein the IV maintenance dose is administered over about 3-12 hours.

Embodiment 136: The method of embodiment 121, wherein the dofetilide is fully loaded in less than three days.

Embodiment 137: The method of embodiment 136, wherein the dofetilide is fully loaded when it reaches steady state concentration in the blood.

Embodiment 138: The method of embodiment 121, wherein the intravenous dofetilide is administered in a first loading dose and an ongoing IV maintenance dose.

Embodiment 139: The method of embodiment 121, wherein intravenous dofetilide administration prevents possible arrythmias by avoiding excessive dofetilide blood levels.

Embodiment 140: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 225-250 μg dofetilide over about 3-12 hours to those patients having a creatine clearance of 40-<60 mL/min;
d. discontinuing the IV maintenance dose for patients who have sufficiently recovered from the electrical cardioversion; and
e. about 2-6 hours after discontinuing the IV maintenance dose, orally administering 125 μg dofetilide every 12 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 141: The method of embodiment 140, which is a method of converting atrial fibrillation (AF) or atrial flutter (AFL).

Embodiment 142: The method of embodiment 140, wherein patients who are highly symptomatic have severe hemodynamic compromise, with symptoms which can include shortness of breath, dyspnea, chest pain (angina), orthopnea, syncope, and diaphoresis.

Embodiment 143: The method of embodiment 140, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 144: The method of embodiment 143, wherein the patient's physician determines when the patient is stable.

Embodiment 145: The method of embodiment 144, wherein the patient may be stable after the loading infusion of dofetilide is complete, or after the first oral doses have been administered.

Embodiment 146: The method of embodiment 141, wherein the loading dose is about 450-500 μg dofetilide.

Embodiment 147: The method of embodiment 141, wherein 1-3 hours after completion of the loading dose, a maintenance dose (“the IV maintenance dose”) of 450-500 μg dofetilide is administered to those patients having a creatine clearance of 60 mL/min or higher.

Embodiment 148: The method of embodiment 141, wherein the IV maintenance dose is 225-250 μg dofetilide.

Embodiment 149: The method of embodiment 141, wherein 3-5 hours after discontinuing the IV maintenance dose, 500 μg dofetilide is orally administered every 12 hours to those patients having a creatine clearance of 60 mL/min or higher.

Embodiment 150: The method of embodiment 141, further comprising measuring the patient's creatine clearance as an approximation of the glomerular filtration rate (GFR), prior to administering the IV maintenance dose, to determine the amount of dofetilide indicated for the IV maintenance dose.

Embodiment 151: The method of embodiment 141, further comprising measuring the patient's creatine clearance as an approximation of the glomerular filtration rate (GFR), prior to orally administering dofetilide, to determine the amount of dofetilide indicated for the oral dose.

Embodiment 152: The method of embodiment 141, wherein the patient has sufficiently recovered from the electrical cardioversion and is orally administered dofetilide when awake after surgery with an intact gag reflex.

Embodiment 153: The method of embodiment 141, wherein the intravenous loading dose is administered over about 30-60 minutes.

Embodiment 154: The method of embodiment 141, wherein the IV maintenance dose is administered over about 3-12 hours.

Embodiment 155: The method of embodiment 141, wherein the dofetilide is fully loaded in less than three days.

Embodiment 156: The method of embodiment 155, wherein the dofetilide is fully loaded when it reaches steady state concentration in the blood.

Embodiment 157: The method of embodiment 141, wherein the intravenous dofetilide is administered in a first loading dose and an ongoing IV maintenance dose.

Embodiment 158: The method of embodiment 141, wherein intravenous dofetilide administration prevents possible arrythmias by avoiding excessive dofetilide blood levels.

Embodiment 159: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 100-125 μg dofetilide over about 3-12 hours to those patients having a creatine clearance of 20-<40 mL/min;
d. discontinuing the IV maintenance dose for patients who have sufficiently recovered from the electrical cardioversion; and
e. about 2-6 hours after discontinuing the IV maintenance dose, orally administering 500 μg dofetilide every 12 hours to those patients having a creatine clearance of 60 mL/min or higher;
wherein the oral dofetilide dose is reduced to 250 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 160: The method of embodiment 159, which is a method of converting atrial fibrillation (AF) or atrial flutter (AFL).

Embodiment 161: The method of embodiment 159, wherein patients who are highly symptomatic have severe hemodynamic compromise, with symptoms which can include shortness of breath, dyspnea, chest pain (angina), orthopnea, syncope, and diaphoresis.

Embodiment 162: The method of embodiment 159, further comprising measuring the patient's QTc prior to intravenously administering the loading dose of dofetilide to establish baseline QTc, thereafter measuring the QTc every 15-30 minutes during the initial infusion, thereafter about every 60 minutes. until the patient is stable.

Embodiment 163: The method of embodiment 162, wherein the patient's physician determines when the patient is stable.

Embodiment 164: The method of embodiment 163, wherein the patient may be stable after the loading infusion of dofetilide is complete, or after the first oral doses have been administered.

Embodiment 165: The method of embodiment 159, wherein the loading dose is 450-500 μg dofetilide.

Embodiment 166: The method of embodiment 159, wherein 1-3 hours after completion of the loading dose, a maintenance dose (“the IV maintenance dose”) of 450-500 μg dofetilide is administered to those patients having a creatine clearance of 60 mL/min or higher.

Embodiment 167: The method of embodiment 159, wherein the loading dose is 450

Embodiment 168: The method of embodiment 159, wherein the creatine clearance is 60 mL/min or higher.

Embodiment 169: The method of embodiment 159, wherein the about 2-6 hours after discontinuing the IV maintenance dose.

Embodiment 170: The method of embodiment 159, further comprising measuring the patient's creatine clearance as an approximation of the glomerular filtration rate (GFR), prior to administering the IV maintenance dose, to determine the amount of dofetilide indicated for the IV maintenance dose.

Embodiment 171: The method of embodiment 159, further comprising measuring the patient's creatine clearance as an approximation of the glomerular filtration rate (GFR), prior to orally administering dofetilide, to determine the amount of dofetilide indicated for the oral dose.

Embodiment 172: The method of embodiment 159, wherein the patient has sufficiently recovered from the electrical cardioversion and is orally administered dofetilide when awake after surgery with an intact gag reflex.

Embodiment 173: The method of embodiment 159, wherein the intravenous loading dose is administered over about 30-60 minutes.

Embodiment 174: The method of embodiment 159, wherein the IV maintenance dose is administered over about 3-12 hours.

Embodiment 175: The method of embodiment 159, wherein the dofetilide is fully loaded in less than three days.

Embodiment 176: The method of embodiment 175, wherein the dofetilide is fully loaded when it reaches steady state concentration in the blood.

Embodiment 177: The method of embodiment 159, wherein the intravenous dofetilide is administered in a first loading dose and an ongoing IV maintenance dose.

Embodiment 178: The method of embodiment 159, wherein intravenous dofetilide administration prevents possible arrythmias by avoiding excessive dofetilide blood levels.

Embodiment 179: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 100-125 μg dofetilide over about 3-12 hours to those patients having a creatine clearance of 20-<40 mL/min;
d. discontinuing the IV maintenance dose for patients who have sufficiently recovered from the electrical cardioversion; and
e. about 2-6 hours after discontinuing the IV maintenance dose, orally administering 250 μg dofetilide every 12 hours to those patients having a creatine clearance of 40-<60 mL/min;
wherein the oral dofetilide dose is reduced to 125 μg for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 180: The method of embodiment 179, which is a method of converting atrial fibrillation (AF) or atrial flutter (AFL).

Embodiment 181: The method of embodiment 179, wherein patients who are highly symptomatic have severe hemodynamic compromise, with symptoms which can include shortness of breath, dyspnea, chest pain (angina), orthopnea, syncope, and diaphoresis.

Embodiment 182: The method of embodiment 179, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 183: The method of embodiment 182, wherein the patient's physician determines when the patient is stable.

Embodiment 184: The method of embodiment 183, wherein the patient may be stable after the loading infusion of dofetilide is complete. or after the first oral doses have been administered.

Embodiment 185: The method of embodiment 179, wherein the loading dose is 450-500 μg dofetilide.

Embodiment 186: The method of embodiment 179, wherein 1-3 hours after completion of the loading dose, a maintenance dose (“the IV maintenance dose”) of 450-500 μg dofetilide is administered to those patients having a creatine clearance of 60 mL/min or higher.

Embodiment 187: The method of embodiment 179, wherein the IV maintenance dose is 100-125 μg dofetilide.

Embodiment 188: The method of embodiment 179, wherein 3-5 hours after discontinuing the IV maintenance dose 250 μg dofetilide is orally administered every 12 hours to those patients having a creatine clearance of 40-<60 mL/min.

Embodiment 189: The method of embodiment 179, further comprising measuring the patient's creatine clearance as an approximation of the glomerular filtration rate (GFR), prior to administering the IV maintenance dose, to determine the amount of dofetilide indicated for the IV maintenance dose.

Embodiment 190: The method of embodiment 179, further comprising measuring the patient's creatine clearance as an approximation of the glomerular filtration rate (GFR), prior to orally administering dofetilide, to determine the amount of dofetilide indicated for the oral dose.

Embodiment 191: The method of embodiment 179, wherein the patient has sufficiently recovered from the electrical cardioversion and is orally administered dofetilide when awake after surgery with an intact gag reflex.

Embodiment 192: The method of embodiment 179, wherein the intravenous loading dose is administered over about 30-60 minutes.

Embodiment 193: The method of embodiment 179, wherein the IV maintenance dose is administered over about 3-12 hours.

Embodiment 194: The method of embodiment 179, wherein the dofetilide is fully loaded in less than three days.

Embodiment 195: The method of embodiment 194, wherein the dofetilide is fully loaded when it reaches steady state concentration in the blood.

Embodiment 196: The method of embodiment 179, wherein the intravenous dofetilide is administered in a first loading dose and an ongoing IV maintenance dose.

Embodiment 197: The method of embodiment 179, wherein intravenous dofetilide administration prevents possible arrythmias by avoiding excessive dofetilide blood levels.

Embodiment 198: A method of treating patients who present with highly symptomatic atrial fibrillation (AF) or atrial flutter (AFL), comprising:
a. intravenously administering to a patient in need thereof a loading dose of about 450-500 μg dofetilide over about 30-60 minutes;
b. after completion of the loading dose, administering electrical cardioversion to those patients who have not converted to sinus rhythm;
c. about 0-1 hour after conversion with electrical cardioversion, intravenously administering a maintenance dose (“the IV maintenance dose”) of 100-125 μg dofetilide over about 3-12 hours to those patients having a creatine clearance of 20-<40 mL/min;
d. discontinuing the IV maintenance dose for patients who have sufficiently recovered from the electrical cardioversion; and
e. about 2-6 hours after discontinuing the IV maintenance dose, orally administering 125 μg dofetilide every 12 hours or every 24 hours to those patients having a creatine clearance of 20-<40 mL/min;
wherein the oral dofetilide dose is discontinued for those patients with an increased QTc of 15% over baseline, those patients having a QTc of >500 msec, or for those patients with a ventricular conduction abnormality having a QTc of >550 msec; and
wherein the loading dose is expected to achieve maximum serum concentration at the termination of the infusion; and
wherein the patient is monitored to ensure no excessive QT prolongation results in cardiac repolarization abnormalities which cause life threatening ventricular arrhythmias.

Embodiment 199: The method of embodiment 198, which is a method of converting atrial fibrillation (AF) or atrial flutter (AFL).

Embodiment 200: The method of embodiment 198, wherein patients who are highly symptomatic have severe hemodynamic compromise, with symptoms which can include shortness of breath, dyspnea, chest pain (angina), orthopnea, syncope, and diaphoresis.

Embodiment 201: The method of embodiment 198, further comprising measuring the patient's QTc prior to intravenously administering the loading dose of dofetilide to establish baseline QTc, thereafter measuring the QTc every 15-30 minutes during the initial infusion, thereafter about every 60 minutes, until the patient is stable.

Embodiment 202: The method of embodiment 201, wherein the patient's physician determines when the patient is stable.

Embodiment 203: The method of embodiment 202, wherein the patient may be stable after the loading infusion of dofetilide is complete, or after the first oral doses have been administered.

Embodiment 204: The method of embodiment 198, wherein the loading dose is 450-500 μg dofetilide.

Embodiment 205: The method of embodiment 198, wherein 1-3 hours after completion of the loading dose, a maintenance dose (“the IV maintenance dose”) of 450-500 μg dofetilide is administered to those patients having a creatine clearance of 60 mL/min or higher.

Embodiment 206: The method of embodiment 198, wherein the IV maintenance dose is 100-125 μg dofetilide.

Embodiment 207: The method of embodiment 198, wherein 3-5 hours after discontinuing the IV maintenance dose, 500 μg dofetilide is orally administered every 12 hours to those patients having a creatine clearance of 60 mL/min or higher.

Embodiment 208: The method of embodiment 198, further comprising measuring the patient's creatine clearance as an approximation of the glomerular filtration rate (GFR), prior to administering the IV maintenance dose, to determine the amount of dofetilide indicated for the IV maintenance dose.

Embodiment 209: The method of embodiment 198, further comprising measuring the patient's creatine clearance as an approximation of the glomerular filtration rate (GFR), prior to orally administering dofetilide, to determine the amount of dofetilide indicated for the oral dose.

Embodiment 210: The method of embodiment 198, wherein the patient has sufficiently recovered from the electrical cardioversion and is orally administered dofetilide when awake after surgery with an intact gag reflex.

Embodiment 211: The method of embodiment 198, wherein the intravenous loading dose is administered over about 30-60 minutes.

Embodiment 212: The method of embodiment 198, wherein the IV maintenance dose is administered over about 3-12 hours.

Embodiment 213: The method of embodiment 198, wherein the dofetilide is fully loaded in less than three days.

Embodiment 214: The method of embodiment 213, wherein the dofetilide is fully loaded when it reaches steady state concentration in the blood.

Embodiment 215: The method of embodiment 198, wherein the intravenous dofetilide is administered in a first loading dose and an ongoing IV maintenance dose.

Embodiment 216: The method of embodiment 198, wherein intravenous dofetilide administration prevents possible arrythmias by avoiding excessive dofetilide blood levels.

Numerous modifications and variations of the present invention are possible in light of the above teachings. It is therefore to be understood that within the scope of the appended claims, the invention may be practiced otherwise than as specifically described herein.

1. A pharmaceutical dofetilide iv composition for use in the treatment of a patient in need thereof, comprising the step of
I. intravenously administering a loading dose of dofetilide to the patient, wherein the loading dose is administered over 30-60 minutes,
II. 0-4 hours after completion of the IV loading dose, intravenously administering a maintenance infusion of dofetilide over 12 hours,
III. when the patient is capable of taking dofetilide orally, stopping the IV maintenance infusion; and,
IV. 2-6 hours after stopping the IV maintenance infusion, orally administering dofetilide every 12 hours;
V. wherein the maintenance infusion given is based on the creatinine clearance (CrCl) of the patient as given in the following Table

| | | IV Maintenance Infusion | Oral Dose |
|---|---|---|---|
| CrCl | | (over 12 h) | (every 12 h) |
| ≥60 | mL/min | 450-500 μg | 500 μg |
| 40-<60 | mL/min | 225-250 μg | 250 μg |
| 20-<40 | mL/min | 100-125 μg | 125 μg |
| <20 | mL/min | Dofetilide not indicated | Dofetilide not indicated |

VI. and wherein a QTc of the patient is measured prior to the IV loading dose of dofetilide to establish a baseline QT_{c} and then measuring the QT_{c} every 15-30 minutes thereafter for 60 min, prior to the IV maintenance infusion and before each oral dose:
VII. provided that if the patient's QTc increases by 15% over the baseline QTc or if the QTc is measured at >500 msec or >550 msec if the patient has a ventricular conduction abnormality, the oral dose is reduced to 250 μg from 500 μg, 125 μg from 250 μg, or discontinued if originally 125 μg.

2. The pharmaceutical dofetilide iv composition according to claim 1 for use in the treatment of a patient in need thereof, wherein the risk of developing atrial fibrillation (AF) and/or atrial flutter (AFL) is reduced in the patient who has undergone coronary bypass surgery (CABS).

3. The pharmaceutical dofetilide iv composition according to claim 1 for use in the treatment of a patient in need thereof, wherein an arrhythmic storm in the patient after implementation of an implantable defibrillator is terminated.

4. The pharmaceutical dofetilide iv composition according to claim 1 for use in the treatment of a patient in need thereof, wherein atrial fibrillation (AF) or atrial flutter (AFL) is converted in the patient who presented with highly symptomatic AF or AFL.

5. The pharmaceutical dofetilide iv composition according to claim 1 for use in the treatment of a patient in need thereof, wherein the patient is intravenously administered a loading dose of dofetilide of 450-500 μg of dofetilide.

6. The pharmaceutical dofetilide iv composition according to claim 1 for use in the treatment of a patient in need thereof, wherein the patient is intravenously administered a maintenance infusion of dofetilide over 12 h of 100-500 μg dofetilide.

7. The pharmaceutical dofetilide iv composition for use in the treatment of a patient in need thereof according to claim 1, wherein the duration between the Cmax dofetilide concentration obtained after administration of the iv loading dose of dofetilide and the Cmax dofetilide concentration obtained after the first oral dose administration of dofetilide is between 14 and 18 hours.
